(19) United States
(12) Patent Application Publication
(10) Pub. No.: US 2020/0202466 A1
(43) Pub. Date: Jun. 25, 2020

(54) LITIGATION MANAGEMENT

(71) Applicant: Kenneth N. Sortedahl, II, Spring Valley, WI (US)

(72) Inventor: Kenneth N. Sortedahl, II, Spring Valley, WI (US)

(21) Appl. No.: 16/721,057

(22) Filed: Dec. 19, 2019

Related U.S. Application Data
(60) Provisional application No. 62/783,610, filed on Dec. 21, 2018.

(51) Int. Cl. G06Q 50/18; G06F 16/16

(52) U.S. Cl. CPC G06Q 50/18; G06F 16/164; G06F 16/168

(57) ABSTRACT

An example system for managing litigation includes: a processor; and memory encoding instructions that, when executed by the processor, cause the system to create: a case module programmed to manage a plurality of litigations, with each litigation including a dashboard including links to a plurality of items associated with the litigation; a template module programmed to provide a plurality of templates associated with parts of the litigation, the parts including both portions of a trial and rules associated therewith; a witness module programmed to store information about a plurality of individuals associated with the litigation; and a facts module programmed to store a plurality of facts associated with the litigation; wherein the facts are coded to link the facts to the individuals.

### RELATED APPLICATION(S)

This patent application claims the benefit of U.S. Patent Application No. 62/783610, Attorney Docket No. 18250.0001USP1, filed on Dec. 21, 2018, the entirety of which is hereby incorporated by reference.

### BACKGROUND

The management of the various aspects associated with even a simple piece of litigation can be daunting. The relevant facts can be spread out through various sources, including deposition testimony, documents, and pleadings. The ability to track and organize this information can be critical to success in litigation.

### SUMMARY

In one aspect, an example system for managing litigation includes: a processor; and memory encoding instructions that, when executed by the processor, cause the system to create: a case module programmed to manage a plurality of litigations, with each litigation including a dashboard including links to a plurality of items associated with the litigation; a template module programmed to provide a plurality of templates associated with parts of the litigation, the parts including both portions of a trial and rules associated therewith; a witness module programmed to store information about a plurality of individuals associated with the litigation; and a facts module programmed to store a plurality of facts associated with the litigation; wherein the facts are coded to link the facts to the individuals. This can include linking the facts and/or the individuals to elements of proof, to a narrative of what is to be proven, and/or to other desired themes within the litigation.

### DESCRIPTION OF THE DRAWINGS

FIG. 1 illustrates an example interface of a system for managing litigation.

FIG. 2 illustrates another example interface of the system of FIG. 1.

FIG. 3 illustrates another example interface of the system of FIG. 1.

FIG. 4 illustrates another example interface of the system of FIG. 1.

FIG. 5 illustrates another example interface of the system of FIG. 1.

FIG. 6 illustrates another example interface of the system of FIG. 1.

FIG. 7 illustrates another example interface of the system of FIG. 1.

FIG. 8 illustrates another example interface of the system of FIG. 1.

FIG. 9 illustrates another example interface of the system of FIG. 1.

FIG. 10 illustrates another example interface of the system of FIG. 1.

FIG. 11 illustrates another example interface of the system of FIG. 1.

FIG. 12 illustrates another example interface of the system of FIG. 1.

FIG. 13 illustrates another example interface of the system of FIG. 1.

FIG. 14 illustrates another example interface of the system of FIG. 1.

FIG. 15 illustrates another example interface of the system of FIG. 1.

FIG. 16 illustrates another example interface of the system of FIG. 1.

FIG. 17 illustrates another example interface of the system of FIG. 1.

FIG. 18 illustrates another example interface of the system of FIG. 1.

FIG. 19 illustrates another example interface of the system of FIG. 1.

FIG. 20 illustrates another example interface of the system of FIG. 1.

FIG. 21 illustrates another example interface of the system of FIG. 1.

FIG. 22 illustrates another example interface of the system of FIG. 1.

FIG. 23 illustrates another example interface of the system of FIG. 1.

FIG. 24 illustrates another example interface of the system of FIG. 1.

FIG. 25 illustrates another example interface of the system of FIG. 1.

FIG. 26 illustrates another example interface of the system of FIG. 1.

FIG. 27 illustrates another example interface of the system of FIG. 1.

FIG. 28 illustrates another example interface of the system of FIG. 1.

FIG. 29 illustrates another example interface of the system of FIG. 1.

FIG. 30 illustrates another example interface of the system of FIG. 1.

FIG. 31 illustrates another example interface of the system of FIG. 1.

FIG. 32 illustrates another example interface of the system of FIG. 1.

### DETAILED DESCRIPTION

Embodiments disclosed herein generally relate to litigation management systems. The systems allow for more efficient and easier management of and access to litigation-related information. The following description provides details on the possible systems.

In the example systems provided herein, work on a file is available to be built on as the case progresses, somewhat like building a pyramid. The amount of time wasted doing rework is minimized. When an officer calls in with a question about a case or seeks a search warrant, that work is stored in a way that is easily accessible by the user as the case builds and progresses and is not walled off away in a piece of paper, in an email program or a word processor.

In the examples provided herein, an organizational system is provided that leverages an easy way to index a table in a database, such as a Microsoft Access database. The user attaches a field and then puts a name in the field that will bunch together when the field is sorted. The approach is akin to a stem leaf diagram, which is a statistical chart where the numbers or figures from the population group bunch together on the y-axis to form a histogram of numbers. This approach adds a solution to the soft search (query or shotgun approach) problem by allowing a search by subject or index to the universe of meaningful facts (i.e., smallest meaningful set of facts).

The smallest meaningful piece of information is the smallest group of words that a reader with knowledge of the case will recognize their meaning, usually a sentence but may be a paragraph. It could be a question and an answer.

The smallest meaningful set of facts (universe of meaningful facts) relates to the idea that, when one works on an issue, he or she wants to be able to limit the information one considers to the smallest meaningful set of facts that allow one to accomplish the task. So, if one is working on a search warrant, the user wants to know all the law and information needed to get the search warrant nothing more nothing less. The horizon of information expands and contracts to include just the amount of information required to accomplish the task.

At various times during a trial, the user may want to expand his or her universe of meaningful facts to an entire trial notebook or at other times reduce the universe of meaningful facts to a much smaller universe such as module on jury instructions during the jury instructions conference, or to just the voir dire module during voir dire.

Indexing (hard search, multiple choice, curating) is a way of sorting information or curating information or bunching information according to a theme or time or author or witness or element. The user will have the exact information that the curator bunched together under that word in the index and the index itself is a collection of curated themes, ideas, concepts, authors, times, dates, etc.

Soft search is a key word search (similar to that provided by Google), which is an easy way to search a large area but is limited by such things as if the word is spelled differently in the searched area, it will not find it, or the search term is not sufficiently specific the return of information to the user may be too large. This is also dependent on the quality of the search engine and the size of the area to be searched.

The concept of free copying of information and free storage of information means that the user can copy a piece of information many times in many different places in a program without cost as the computer allows the user to cut and paste and copy documents easily. This differs from paper copying and storage, which are too expensive in time space and money. This is a transformative concept, as the time needed to copy and the storage cost of copying are reduced to almost zero from the more significant copying costs associated with paper use. It further frees the user from the physical confines associated with paper, giving the user the freedom to work more efficiently and at differing locations.

An example is if the user of a paper trial notebook puts a copy of every page in the file that is associated with information about which a witness will testify, that page may have other information that a different witness will need to testify to or the other witness can testify to the same information, that paper page must be copied and placed into the trial notebook at each relevant location. This is a lot of work and makes the paper copy nearly impossible to carry.

The computer also frees the user to copy any amount of information, whether it is as small as a letter or as large as libraries and that data can be used by the computer as it is inputted into the computer, this contrasts with paper where the information is contained and highlighted on a page (and the entire page distracts from the highlighted/important portion) or in a book (and then the book must be carried around to use the highlighted/important portions). The computer allows what paper does not: effortless use (e.g., organization/reorganization) of multiple copies of the same piece of information/same book/same library/same template/same file.

Lastly, free copying allows the user to open multiple copies of the universe of meaningful facts that the user happens to be working on, all open at the same time and all updated continuously as any copy is updated. This could be replicated by only a team of people, the cost of which would make it impossible. Another way of saying this is it is as if the computer allows a user to go into a library building, open up as many reports, and cases and books as necessary to solve a problem and then instantaneously copy the entire table and set it up nearby. The user could make as many copies as necessary, one for co trial counsel, one for looking at a different place in the data on one table and then move over to the other table to look at a different portion or facet of the same case. All while the work is updated simultaneously so that any work done at any of the library tables is simultaneously updated on all of the library tables.

The system starts with a library of all-important documents that the user wants access to in her/his practice. This is the user's largest “Universe of Meaningful Facts” and could contain everything that is useful to the user in her/his practice.

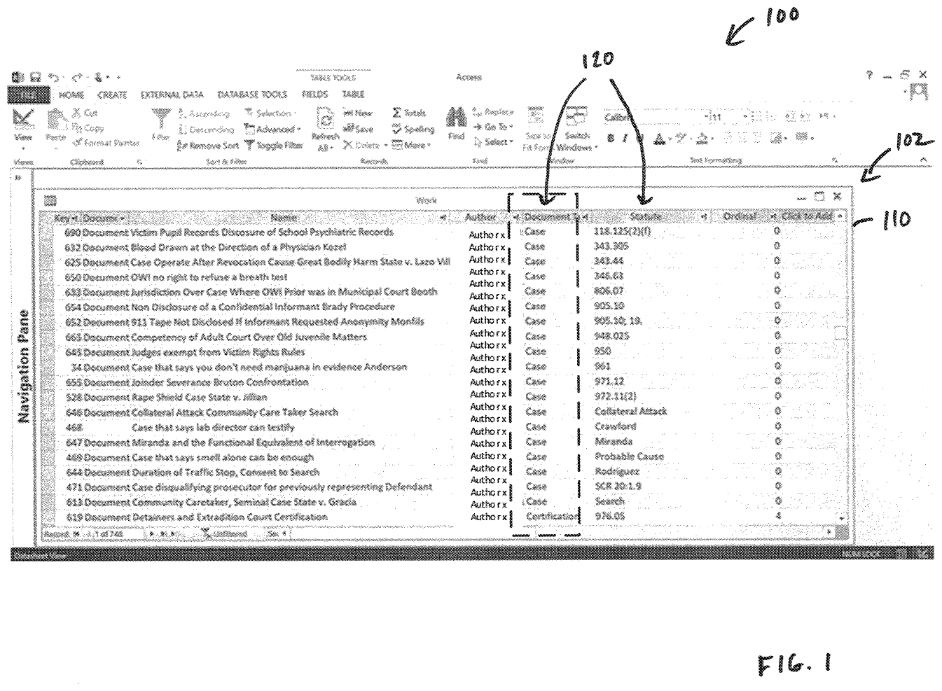

The interface 100 of FIG. 1 is an example of a portion of a library 102 in Access. It is a Microsoft Access table 110 with fields for each type of information that the user wants to be able to sort the database with. Notice that this is a one-to-one relational database. One-to-one means that the user can create or use multiple fields 120 (in the below example the field is named “name,” “author,” “document type,” and “statute”), but only one piece of data can go into a field. So, for example below, one author's name is associated with the document, or one statute. With this system, the user gives up the ability to relate multiple (many) items in a field to one document (field) but, in exchange, the user gains a simpler database. Later, there will be a discussion of how to put or relate multiple pieces of information in a field to the rest of the record, (row in Excel). This is referred to as a one-to-many relationship as opposed to a one-to-one relationship.

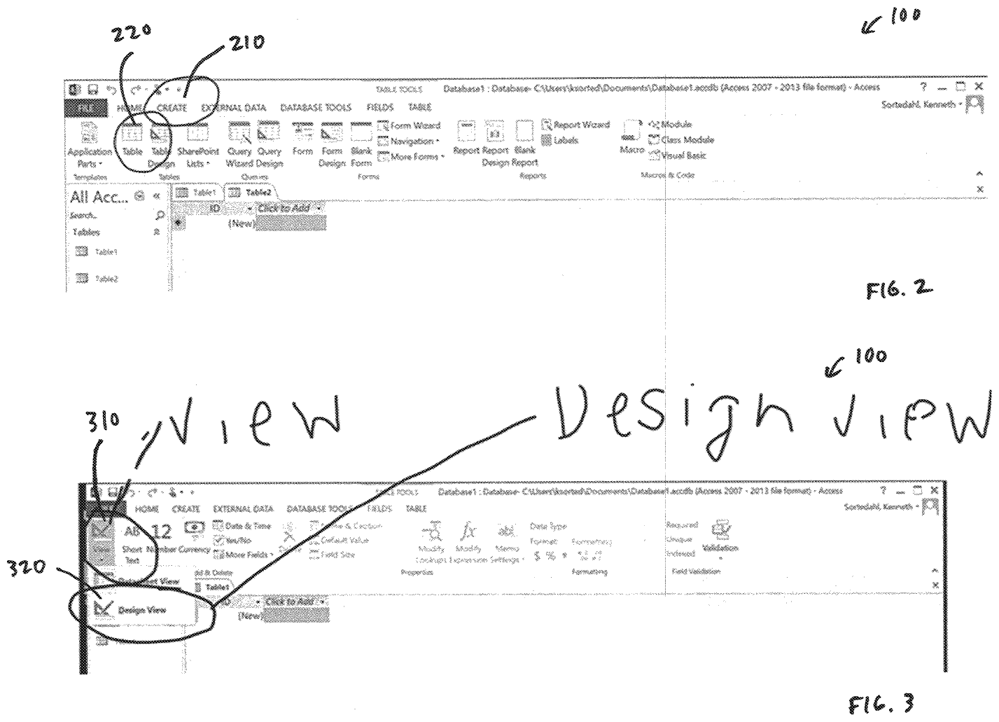

The way to create the table 110 is shown in FIGS. 2-3. In this example, the user is to open a new Access Database by selecting the “Table” control 220 in the “create” tab 210, as shown in FIG. 3. Then, the user selects the “View” control 310 and then the “Design View” control 320, as depicted in FIG. 3.

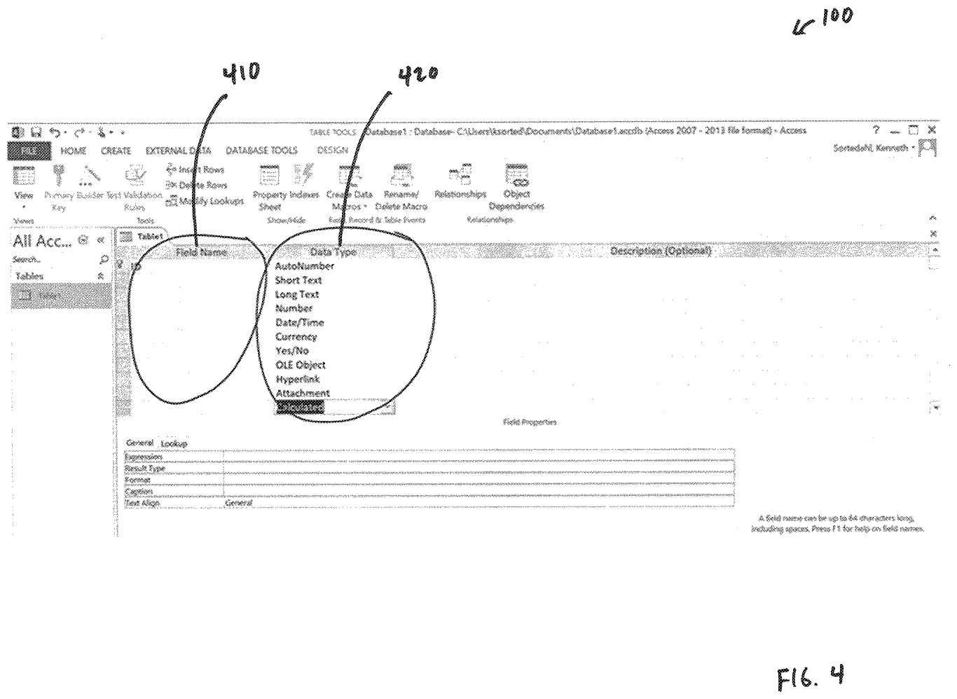

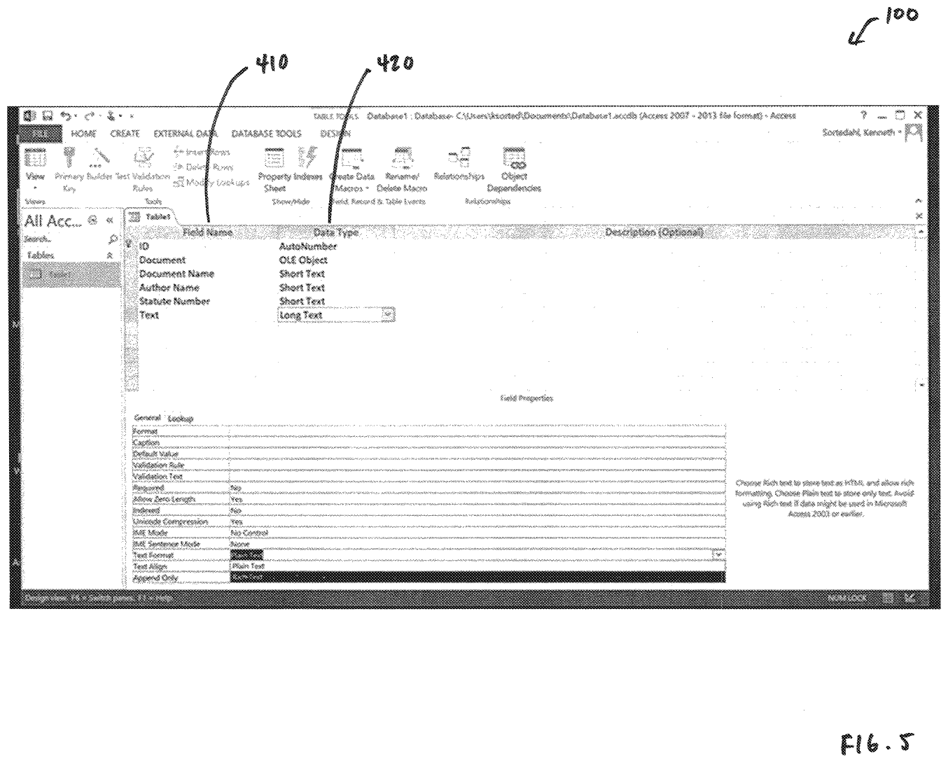

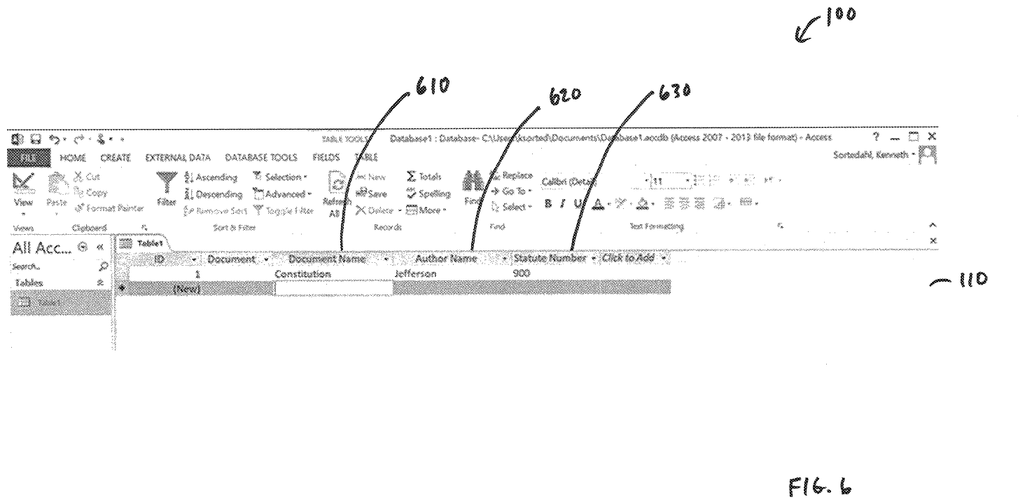

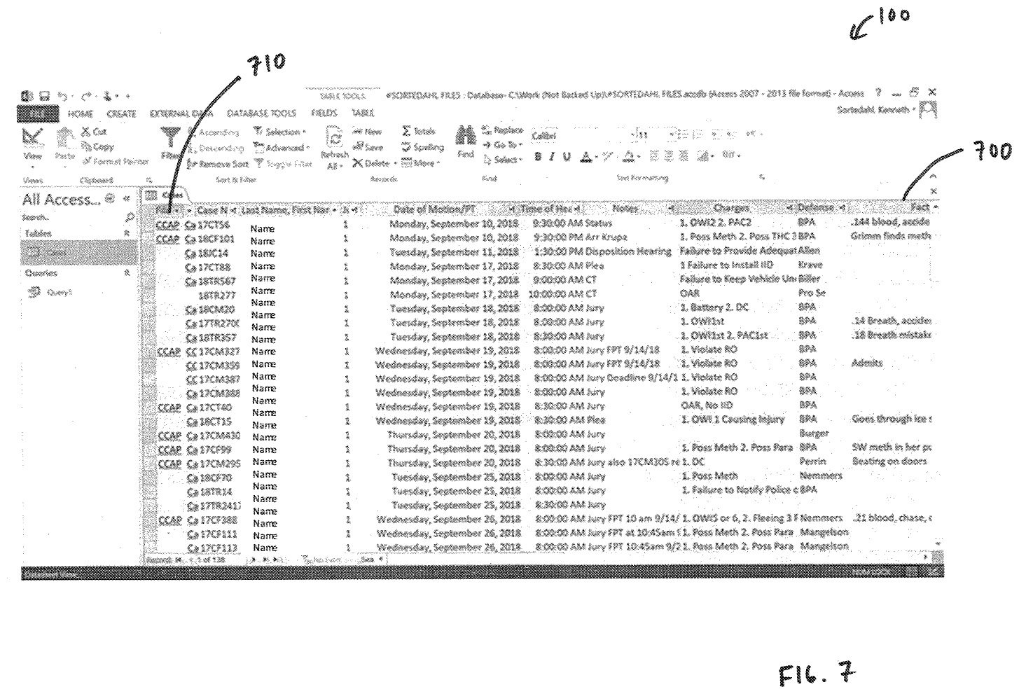

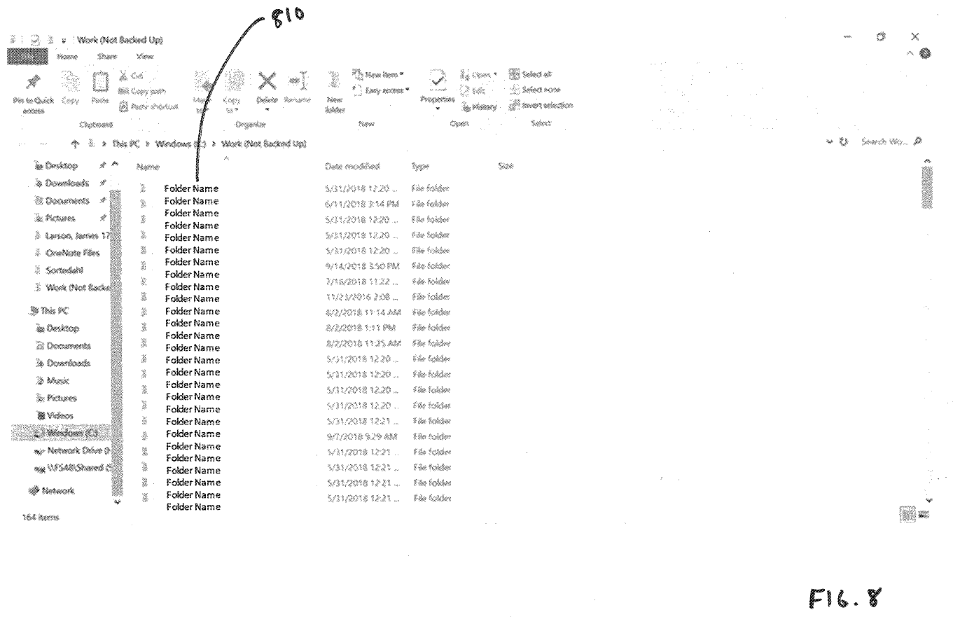

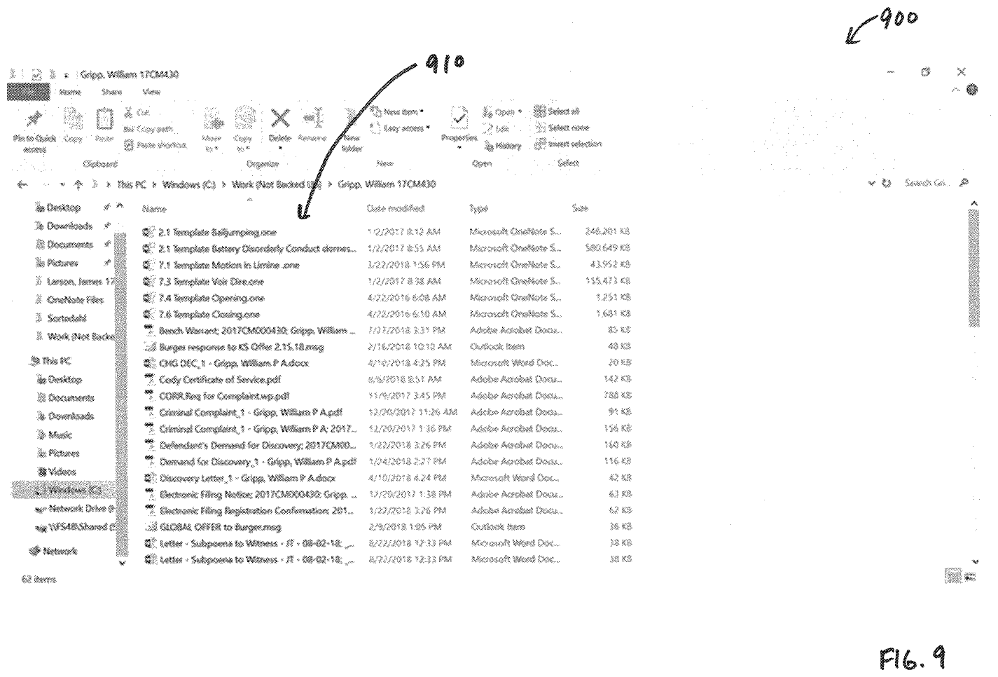

As shown in FIGS. 4-5, the user can create a field 410 by naming it and then designating the data type 420 the field will hold. AutoNumber is a field Access uses to automatically assign a unique number to each record the user makes, Short Text allows the user to input up to 255 characters in the field, Long Text allows the user to input nearly any amount of text into a field and if the user goes to the General tab after designating a field Long Text, the user can open the drop down box at Plain Text/Rich Text and this enables the user to highlight, underline, change text color, (anything a user can do in HTML), this function is useful later when one document or fact is related to many themes or key words or is indexed, Number is used for data that is a number, Date/Time is used for entering dates, Currency is used when storing money values, Yes/No is useful when the user wants to sort by yes or no so for example if the name is “Has this document been updated? Yes/No, OLE object is useful if the user wants to copy a document into the table, (this is useful if the document is not frequently updated, or if the user wants the document to become part of the database, when creating a library, the field where the document itself will be located should be designated an OLE, (later versions of Access do not have OLE so the user should use the Attachment designation instead).

Hyperlink is useful if the user wants to link to a document that is frequently updated as the link will always go the version that is updated, the drawback is if the user's computer does not have access to the location of the document such as if the document is on the internet and the user has no internet access or if the document is on a shared enterprise drive and the user has no access to that drive, the link will not work until access is reestablished, Attachment is like OLE except that multiple documents can be placed into one cell/field, Calculated is when the user wants to put a SQL type of formula into a an Access cell/field, last is LookUp Wizard and is used in this system to properly attach tables together (more on this later).

So, first is the document field, the field where the individual document will be stored in the table that is to be the user's library. This is designated as either an “OLE Object” or an “Attachment”.

The next field should be the “Name” so that should be designated “Short Text” (this is if the name is less than 255 characters, though this can be increased) “Long Text”(if the name is longer than 255 characters) and “Rich Text” (if the user wants to highlight or bold or change font size in the name).

The user should add as many fields as necessary to adequately sort the list of documents (the records). Note there are several different field types the user must choose from depending on the type of data the user will input into the field. There are calculated field types and date field types and number field types and hyperlink field types.

Now when the user goes back to View, the table 110 will look as shown in FIG. 6. The user drags and drops the document into the document field 610 and then names it “Constitution”, puts in the author name 620 and the statute number 630. The reader may wonder why the author used short text for the statute number rather than number and that is because it will sort better when the number is looked at by Access as text rather than as a number.

When the user sorts by field, the names that are the same will bunch together and thereby give the user all the documents that share that common name. This is a way to see all of the documents in the library that are authored by the same person or that pertain to the same statute.

The library 102 is the source of the documents. Later, the user will create an Access Table identical to the library in name and fields but the Micro Library will contain a subset of documents that will be inserted into the template that user is working on for a particular part of a particular case. This is the concept of always limiting the user's work horizon to the largest meaningful set of facts/law.

All cases are put into a similar (to the Library) Access table, stem leaf. In other words, this is a library of the user's cases rather than documents. The Access table allows sorting by field, in the same way that the library is sorted and it allows links 710 to other databases, such as the court's system (e.g., the State of Wisconsin database maintained by the Clerk of Court's Office that contains case information, referred to as the Consolidated Court Automation Program (CCAP)) and to the cases themselves, the user can attach documents as well. See FIG. 7 for an Access table 700 set up in the same way as the library 102.

So much the same way that a table is created in Access to organize the user's library, a table is created to organize the user's case files.

In the above example the user would open a new blank database, go to the create tab, go to the “Table Design” button and name the field and designate the type of data that each field will accept. In the above example, the first field is a “Hyperlink” field to the CCAP state database of all court cases in Wisconsin Circuit Courts. Field two is a hyperlink field that allows the user to hyperlink directly to the case file. The third field is a “Short Text” field that contains the case alphanumeric number. The next is a “Short Text” field that contains the defendant's last name and first name. The fifth field is the court branch where the case is assigned, and the sixth field is the date of the next hearing so this field has to be designated “Date/Time.” The next field is the time of the next hearing and that field also must be designated “Date/Time.” The next field is the type of hearing and should be designated “Short Text.” The next field is the defense attorney name or initials and should be designated “Short Text.” The next is a short factual description of the case.

It can be important to use a naming convention (where the user always uses the exact same name or label for a field so that they will bunch together when sorted) because the purpose is to allow the user to sort the cases by any field and get the cases to bunch together after a sort by judge, or by defense attorney or by type of case.

The fields themselves can be moved back and forth in the table by clicking on the boundary at the top of the field name until the line gets heavy and then dragging it left or right on the table.

The user can sort multiple fields at the same time by holding down the shift key and then clicking the respective field until it highlights, Access will sort the first table first then the next field next. This is important when sorting the branch calendar by date and time.

The most important field is the “Hyperlink” field that connects the table to the folder containing all the cases. (the table is an organizational overlay of the user's cases folder).

The user can replace this step by using a different database, so for example as a Wisconsin prosecutor, we use a database known as Protect. That database can take the place of the Case Table as the user can insert a Microsoft Word document into the list of documents and name it anything like Master Document. When that Document is open, the user can insert a hyperlink to the file saved on the user's hard drive in the same way that the user above hyperlinks to the file above. In this case, the user would use the Protect Database to find and sort files rather than the above-described Case Table.

The above case table 700 (or Protect hyperlink) is linked to a folder in the cloud or on a hard drive. That folder contains all the cases named with a naming convention. Folders 800 sort by number or symbol first and then alphabetically, as shown in FIG. 8. The folders 800 contain everything that is typically in a case, correspondence, subpoenas, reports, emails, videos, recordings, and photos, all in electronic form.

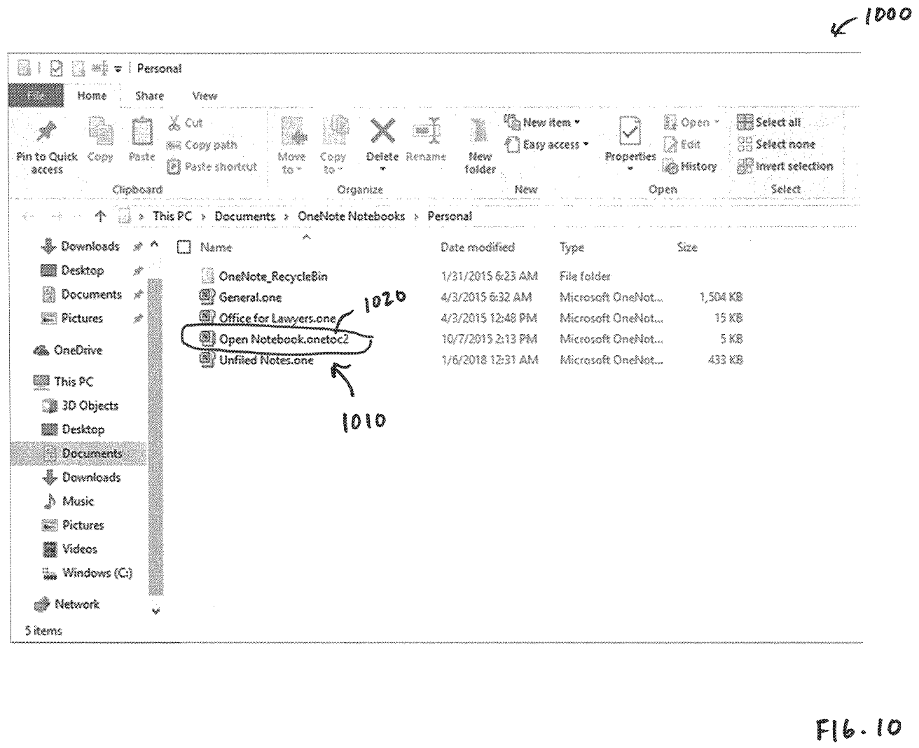

FIG. 9 is an example of a folder 900 that contains all the respective files called “Work (Not Backed Up)”.

This is the contents of the case contained in the respective case folder. Each document 910 is named and placed here. When the Access field in the case table is clicked with the mouse, the hyperlink will take the user into this folder 900.

The user then places OneNote template files into the respective case folder 900 which the user creates (fashions) a tailored (bespoke) file, which once tailored, becomes a module of organized case specific information.

But first, the user has to create the templates using a word processing and/or notes program, such as Microsoft OneNote. This is how templates are made.

OneNote files organize the case from within the folder. Use the concept of the smallest meaningful set of facts to create templates. Each template is a subset what could become part of the user's case. The user creates a sort of a library of templates that are organized by each stage of what happens in a typical case. Imagine each stage of a case, really imagine a part of the case that contains the smallest meaningful set of facts that the user concentrates on in one sitting, (examples are search warrant, charging decision, motions, voir dire, opening, closing, post-conviction, etc.).

These templates should be roughly equivalent to or broken down to a level that includes the smallest meaningful set of information. Once the template library is complete, the OneNote Template is copied from the template library into the case folder so that it can be used to organize the respective case to which it is assigned. This allows an organization to put their star players in charge of authoring or drafting the best templates available, which will contain foundation questions, micro library, etc. These can be very large, as the user will erase unnecessary pieces of information as the case-specific OneNote template emerges for use. When the OneNote template is crafted into a case specific document, it will be called a module for purposes of this system.

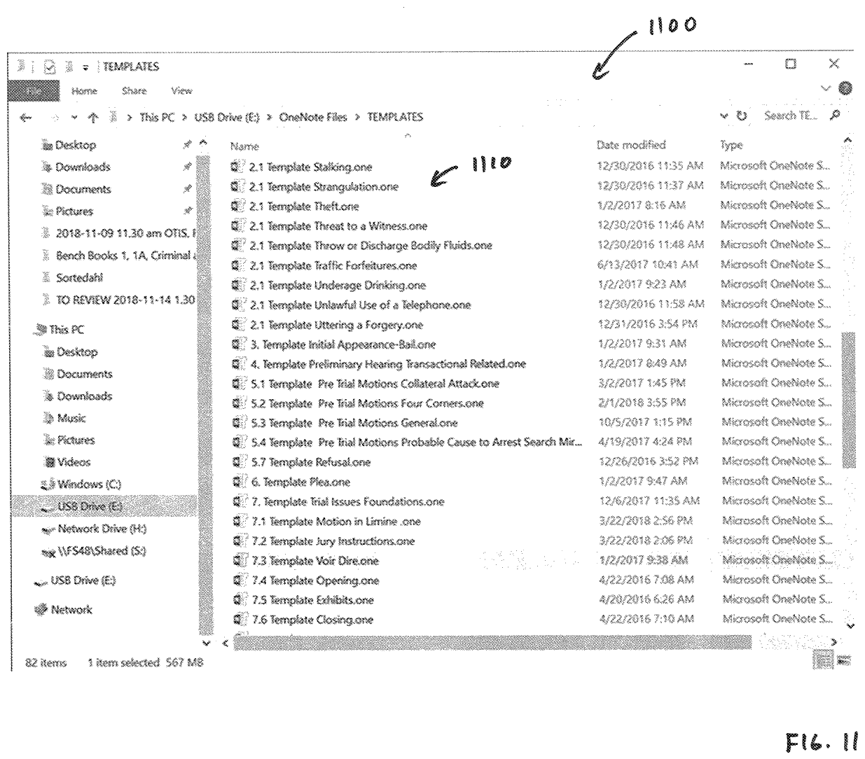

OneNote organizes itself hierarchically. This means Notebooks contain Sections, which contain Pages. The standard Microsoft organization is similar (the Windows folder/file system of organization) though OneNote tries to organize automatically. So, to compare OneNote to any other type of Microsoft program such as Word, an OneNote section is the same as a file in Word. In OneNote, each section has multiple pages whose name displays down the right side of screen. The Word document can be named and put into a file and then the file can be named, so there is a hierarchical system, much like Word. When a Word file is closed, the user can, outside the program so to speak, name it and place it into a folder. In OneNote, it is as if the designers pushed the hierarchy down a level. In interface 1000, the pages 1010 shown in FIG. 10 are on the right. When OneNote is closed, the file contains multiple named pages and then the user can name the OneNote file. When the file is subsequently opened, that file opens into OneNote as a Section.

In reality, an OneNote file is a section. So, in addition to the typical file that can be moved around the operating system, once the file or OneNote section is opened by the user, OneNote displays each section as a tab near the top of the open OneNote page. This is important as the user can open another section at the same time and OneNote places them together separated at the top by a tab and easily accessible to the user who clicks on the respective tab that the user wants to open. This is how the universe of useful information available to the use is expanded and contracted easily. OneNote puts each section (file) into a folder and calls it a Notebook. OneNote displays each Notebook on the left side of the page. This is a problem as OneNote does it automatically.

The problem comes about when there are multiple notebooks, more than a user needs to see. This is why the user has to substitute the above Access library 102 of case folders instead of using OneNote. OneNote wants to take every Notebook on any given system (system meaning any hard drive, thumb drive or storage device) and put them all together, and automatically runs them down the left side of the screen in an open OneNote program. This is useful if there are not many Notebooks on the system but quickly becomes cumbersome and tedious to a user who has scores to hundreds to thousands of Notebooks (in this system these would be cases). This is what would happen if the user tried to make a Case into an OneNote notebook.

A typical lawyer needs a system that allows hundreds of open cases that can be organized in a way that the lawyer can navigate through them. If OneNote's system of having a Notebook for each case is used by a lawyer, then cases will eventually bunch up on the left side of the screen and eventually become almost impossible to organize. Thus, the user may wish to modify OneNote to address this issue.

What is required is a way to organize OneNote files like every other Microsoft Office program. This requires the user to circumvent OneNote's automatic Notebook organization. The way to bypass that is as follows.

First, find the folder where OneNote is storing the files. This will normally be in the Documents folder, the default location for OneNote. Move this folder out onto one's desktop. Rename it something like “My OneNote Files” or “All Cases.” Now remember that each OneNote file is the equivalent of a section in OneNote. In this system, each case will be an OneNote Section. Discard the Open Notebook.onetoc2 file 1020. This is the file that organizes everything into notebooks.

Once that file is gone, the user decides what sections to open by double clicking them. What sets OneNote apart though is that more than one section can be opened at a time. Each time a section is opened, it appears at the top of the window. Once opened, the sections can be searched or summarized together. This is the pyramid-building concept. More on this is provided later.

The important thing to observe is that each section appears as a file when OneNote is closed. The file can be stored in a folder, it has a name, and it can be copied like any other file, by dragging and dropping it into a different storage device.

A template is a file that the user intends to use over and over again. Once it is set up, whenever there is a new case that requires the same type of information, the user can go to the template library, copy the template and then use the template for reference or to manipulate the data contained in the template.

The first step is to create a folder on the desktop. Call it “Template Library.” Now copy an OneNote file into the Template Library.” Make as many copies of the OneNote file as one intends to make templates by right clicking the OneNote file and the right clicking in a different place and using the “copy” command to make numerous OneNote files. Then rename the files according to the template the user wishes to set up. If the user is a prosecutor in Wisconsin, for example, the following are suggestions though they may apply to all users.

Template Main File (examples indented below, these are the main part of the case where the factual sources will be placed)

Template Child Support

Template Child Abuse

Template Contributing to the Delinquency of a Child

Template Battery/DC

Template Sex Assault

Template Criminal Damage to Property

Template Traffic

Template Juvenile

Template Battery to Law Enforcement

Template Stalking

Template Suffocation/Strangulation

Template Maintain a Drug House

Template Possession with Intent to Deliver and Delivery

Template Imitation Controlled Substance

Template OWI

Template OWI Injury

Template Possession of . . .

Template Uttering a Forgery

Template Criminal Trespass

Template Homicide

Template Recklessly Endangering Safety

Template Possession of a Firearm by a Felon

Template Burglary

Template Theft

Template Sentencing

Template Extradition

Template Motion to Suppress-Probable Cause

Template Motion to Suppress-Statements

Template Motion to Suppress-Four Corners

Template Collateral Attack

Template Search Warrant

Template Search Warrant Suppression

Template Motions In Limine

Template Voir Dire

Template Jury Instructions

Template Spanish

Template Opening

Template Closing

Template Expert Witness Motion

Template Competency

Template Speedy Detainer

Template Appeal

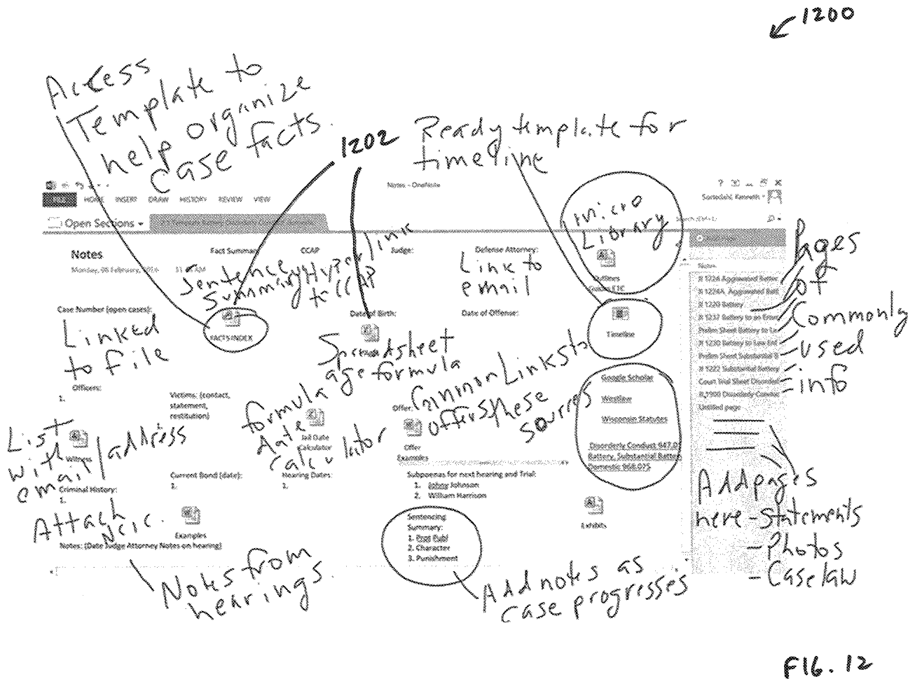

An example of a Template Folder (Library) 1100 including a plurality of templates 1110 is shown in FIG. 11.

The user could start the name with a number. The number will sort the templates so there is order each time they are copied into their respective case file when ready for use. So for example, a lawyer will want the templates to sort into a trial notebook. The user will put a lower number on the OneNote section template so that later the OneNote sections will sort automatically into the trial notebook. So the template for Voir Dire would have a lower number than the template for Opening Statement which would have a lower number than the template for closing statement. Because voir dire comes before opening, this also serves to order the OneNote sections when more than one is open at a time.

Conversely, there should be files or templates that tend to overlap each other or would be selected by the user over a similar folder, so for example there may be a OneNote template for Miranda Motions, for Probable Cause motions, and for Four corners Motions. Since there will likely be only one of these motions filed, the user should use the same number in front of the name so that when it is copied into a case file, it will hold the same position in the case file.

OneNote is part of the Office Suite from Microsoft and allows attaching useful files from any other Office program and also non-Office programs. OneNote allows this in a dashboard format. So, the organizing OneNote file contains a dashboard with individual apps or files from any other program the user finds useful to the file and they are two clicks away from the user at any given moment. Individual pages are used to prepare testimony for individual witnesses and to put copies of each piece of evidence that relates to that witness. Entire books can be copied into the OneNote section. So, the jury instructions and the statutes, and the evidence book can be two clicks away and since copying is free, the user saves time looking for the book as a copy has been made a part of the case and since the copy of the book is part of the case, there is no need to keep it pristine, it can be marked and highlighted by the user as it relates to that particular case.

One can do one or more of the following using the library 102.

Using unrelated programs to include in the OneNote dashboard. Using Access to index the facts of the case.

Using Excel to count days for jail credit or age of defendant.

Using Access tables to maintain lists of witnesses, or a micro library (e.g., template-specific documents from the full library described above), hyperlinking to statutes or to maps or to a shared document on a shared drive on an internal network or on the internet (useful when regular updates are made by others to a document).

Using an Access table to organize the user's case specific email into a tree (this is a list of emails that can be set-up with the case for nearly automatic notice of witnesses or victims or offers to defense attorneys).

Within each template 1110, the user should organize the case as they wish using the principle of limiting the template to the “smallest useful set of facts” so for example a template could have a page for a particularly important jury instruction, a page for a particularly important case, a library Access table insert (micro library) where a copy of each outline, seminal case, is pasted or copied from the main Access table library, it could contain several pages for pattern witness questions (foundational or predicate questions), copies of or hyperlink to the relevant statutes, and pages for any other type of information that always relates to this type of template. In the above example, this organizing template could be any template from “Template Child Support” to “Template Theft.” Only one of these templates will generally by selected by the user for copying and using in a new case folder and thus should have the same organizing number in front of the name. The other Templates are add-ons that complement the main template. These are the Templates above “Template Sentencing” to “Template Appeal.”

For example, setting up a template for a Battery/Disorderly Conduct case could be as follows.

A dashboard 1200 in FIG. 12 is the organizing page of the case/folder. The idea of the dashboard 1200 is to get as much condensed information about a case onto this page that an attorney could have a basic understanding of the case by looking only at that summary or dashboard page. Also, this OneNote template will become the main OneNote file to keep notes about the case. In the above example of templates, it would be Template Battery/DC.

From the dashboard 1200, the user can create hyperlinks 1202 to information contained in the OneNote file, the user's computer, or the internet. For example, the name of the defense counsel could be hyperlinked to that person's outlook email address, to their cellphone (using Skype), or the defendant's name is hyperlinked to the defendant's CCAP page.

The user can insert files from elsewhere. The files become a part of the OneNote file and are opened by the user with a click. This is especially useful when the user wants to take a template and make changes that only are needed in that specific file. So for example, the user has a template word document for a preliminary hearing, where the charge is possession of methamphetamine, the user can insert the word template into the dashboard and then make case specific changes to the template. Another example is inserting an Excel template to calculate the defendant's age or to calculate jail credit.

At the top of the dashboard, for example, should be the case name, case number, assigned judge, defense attorney. The second line would contain a fact summary, victim information, witness lists, and information about each court hearing.

OneNote organizes the case file. Each OneNote file should have the smallest meaningful set of information. OneNote allows the templates, once the template is shaped by the cases respective information, to be combined. Each template becomes a “section” and with the combined sections a notebook. This is important as it allows the user to concentrate on as many sections as the user needs so for example when the user is preparing a Motion, the only section that needs to be open is the Motion section. But if the user thinks the Motion issue may arise at trial, at the time of trial, the Motion file (section) can be opened into the trial notebook (and is therefore consistent with the notion of building the pyramid and being able to concentrate on the smallest meaning set of information at any given time.)

Each page is assigned to a yet smaller “smallest set of useful information” so, when one stands to make an opening statement, he or she does not want to be burdened or confused by a list of foundation witness questions for the first witness. Each page can be broken down further by fact or smallest useful piece of information, which can be color-coded for ease of source recognition when the fact is reformulated into a different document. So copy the witness report onto the witness page, then break the report into the smallest useful piece of information by giving each sentence or paragraph (depending on how one wants to see it later the point is that there should be enough information in the piece of paragraph or sentence that the user could look at it later without context and know what it means). Then assign that piece of information a Bates number or a way to identify it. Then each piece of information can be tagged with an index name and compiled into an index. Or, when a “Google” search is made, the user will know exactly where in the section specific piece of information came from.

The following is an example of how the user organizes the pieces of information, the smallest useful pieces of information together into an organized case file.

As noted above, OneNote is organized differently than other programs in Microsoft Office. OneNote has notebooks on the left hand side of the screen. The notebooks are called “Flaherty,” “CARE,” and “OWI Template.” The tab along the top is a section within an open notebook. The tabs along the right hand side, in blue are pages within the section.

The facts (i.e., the smallest useful pieces of information) of the case come from many sources. In a criminal case, the facts come from police reports, witness statements, physical evidence, photos, and transcripts. Create a page by clicking on “New Page” in the upper right hand corner. Then name the page. A routine way of naming things is important. The larger the case the more important this becomes. The naming convention should be uniform, always the same, it should be specific so that one item does not get confused with other items, and it should be unique.

Name the page the same as the name of the document. Be as specific as possible. Generally use the date the evidence was authored and the name of the author. Then copy the electronic copy onto the page. There are two types of copies. There is the type of copy that is in a Word type format. In this format, the letters and words of the document can be changed, searched for, cut and pasted, enlarged, highlighted with the highlighter, and become part of the text, basically treated as if they are in a Word document. In this format the words that come after an “enter” or a carriage return, can be tagged. The other way a document can be copied is as a picture. In this format, the picture can be stretched and resized, but, generally, the text is not changeable, the text cannot be copied and the text cannot be tagged. The only way to tag this text is to copy the important relevant parts in the margin and then tag the note that was just added.

It is usually better to copy using the text. The easiest way to do this is to open the document that is to be copied and then go to “file” then “select all” then “control c” then go to the page in OneNote and place the cursor on the page and type “control v.” There are other ways to get documents into OneNote but the documents come into OneNote as a picture. So for example, left click on the report file that will be placed into OneNote. Drag it onto the page. Then release the click. OneNote will open a box called Insert File Options. Specify how one wants to insert the file: Insert a link to the original file; Insert a copy of the file onto the page; Insert the file as printout so one can add notes to it; (generally, the third is the most useful, select that and then click the “OK” button. Another way to import the document is to “Print to OneNote” from the print screen. This will import the document to OneNote as a picture.

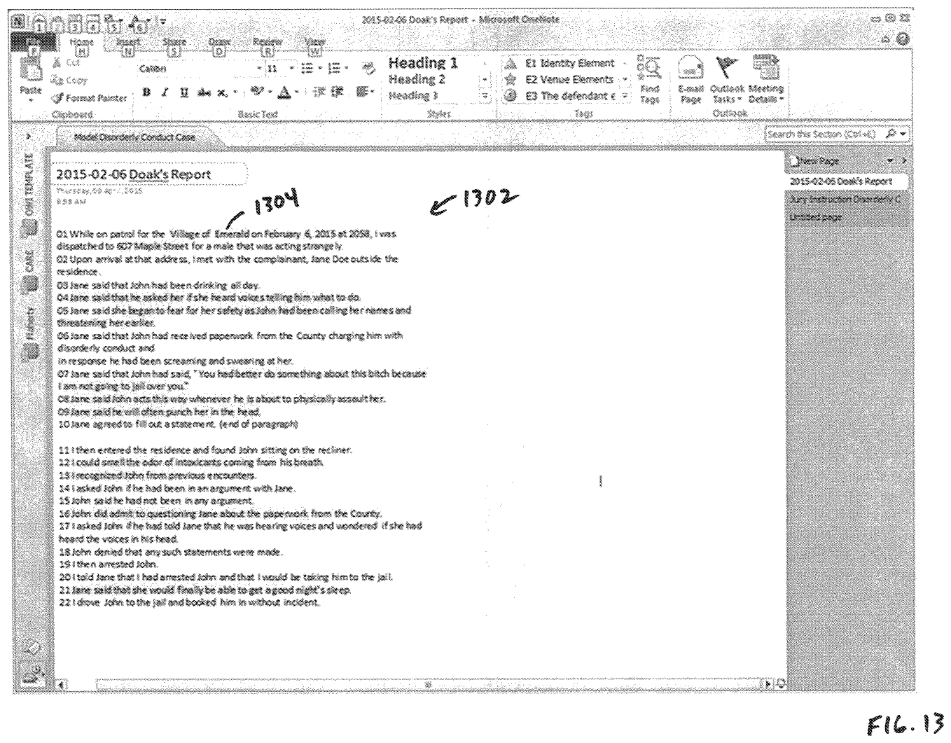

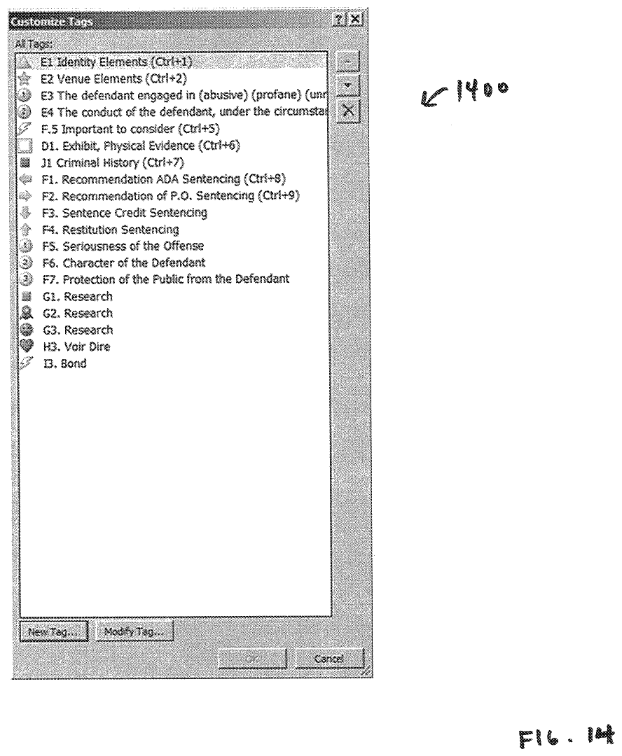

Copy Officer Does's police report and paste it into the page titled 2015-02-06 Report 1302. Since this is in text form, each sentence should be separated from the next with an “enter” or a carriage return. Label each sentence with a unique number so that it can be identified on its own. Then highlight 1304 the relevant portions that are important, as shown in FIG. 13.

Now each sentence that is important can be tagged with the element or issue to which it relates. So, this is a disorderly conduct case and so the issues or elements are: 1. Identity; 2. Venue; 3. The defendant engaged in (violent) (abusive) (indecent) (profane) (boisterous) (unreasonably loud) (or otherwise disorderly) conduct; and 4. The conduct of the defendant, under the circumstances as they then existed, tended to cause or provoke a disturbance.

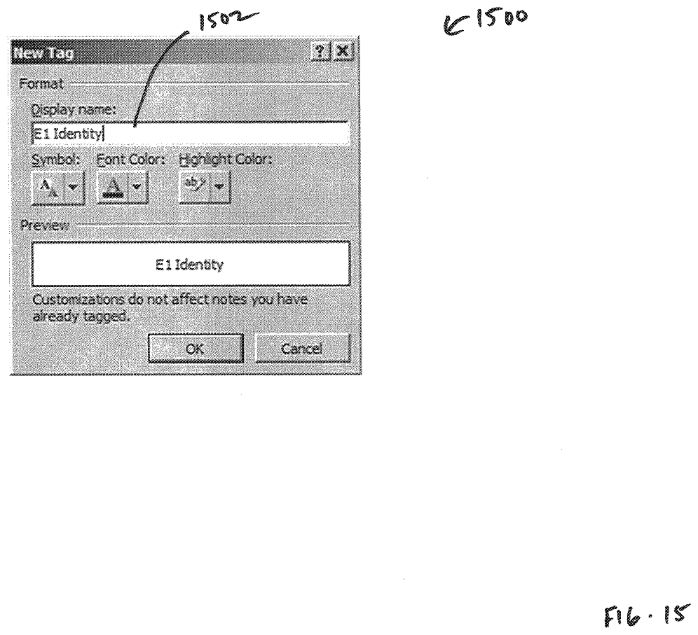

The tags have to be named. Go to “Home” then click on the “more” button on the bottom of the tags list and to the right. This will show all the tags in a window 1400 as shown in FIG. 14. Left click on “Customize tags . . .” then go to the bottom of the box and click on “New Tag.”

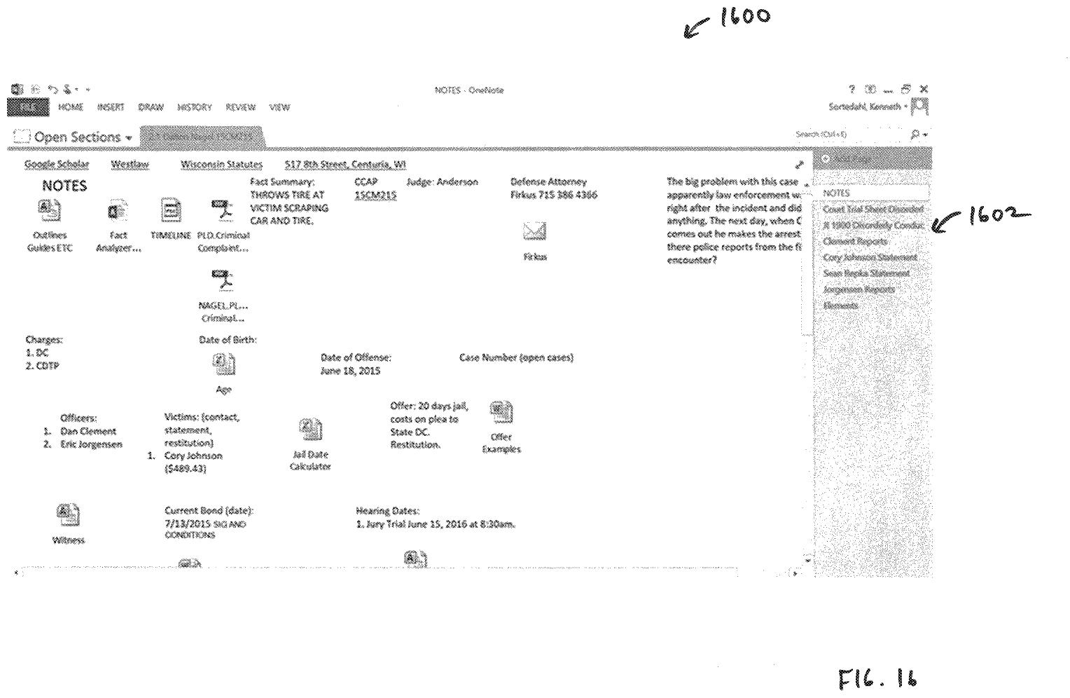

A new box 1500 as shown in FIG. 15 will open.

Type into “Display name” field 1502 a number letter identifier, “E1” and then the name of the element “Identity” then go to symbol and select the green triangle, leave the font black but notice all the font colors, do not highlight but notice all the colors under “Highlight Color.” Then click OK.

Now go to the “Customize Tags” box 1400 and notice that the tags can be ordered by selecting one (clicking on it) then clicking the up or down or delete box. In the same way, a tag can be modified using the “Modify Tag . . . ”

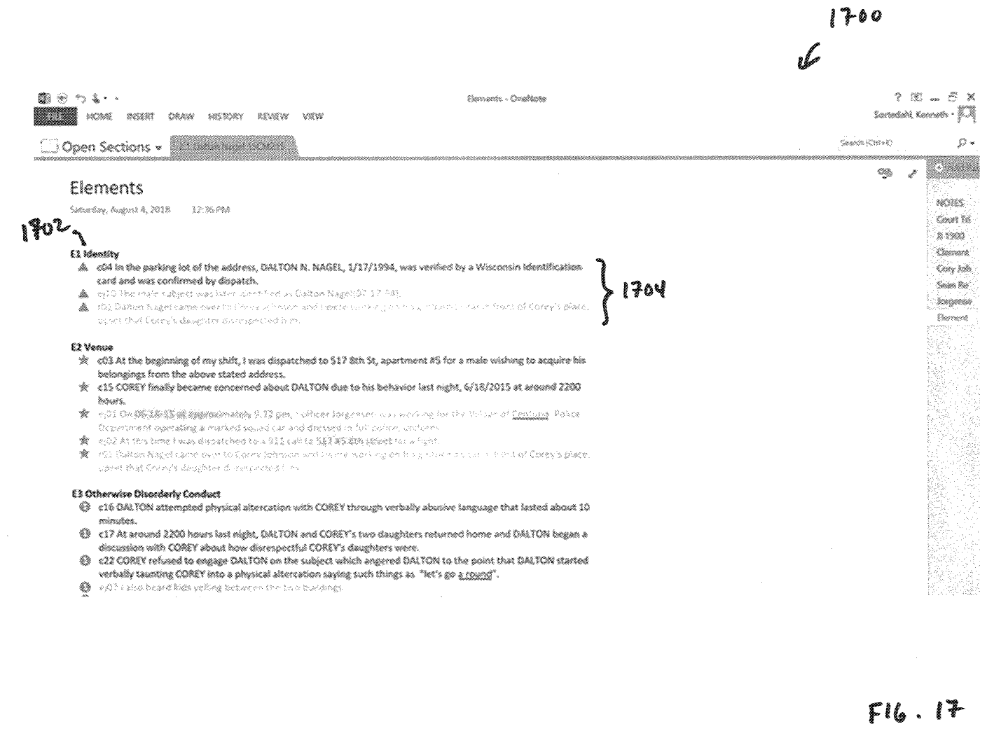

Another example of a case dashboard 1600 is shown in FIG. 16. Note the names pages or tabs 1602 on the right side. The user places all information from the case concerning that person with the name.

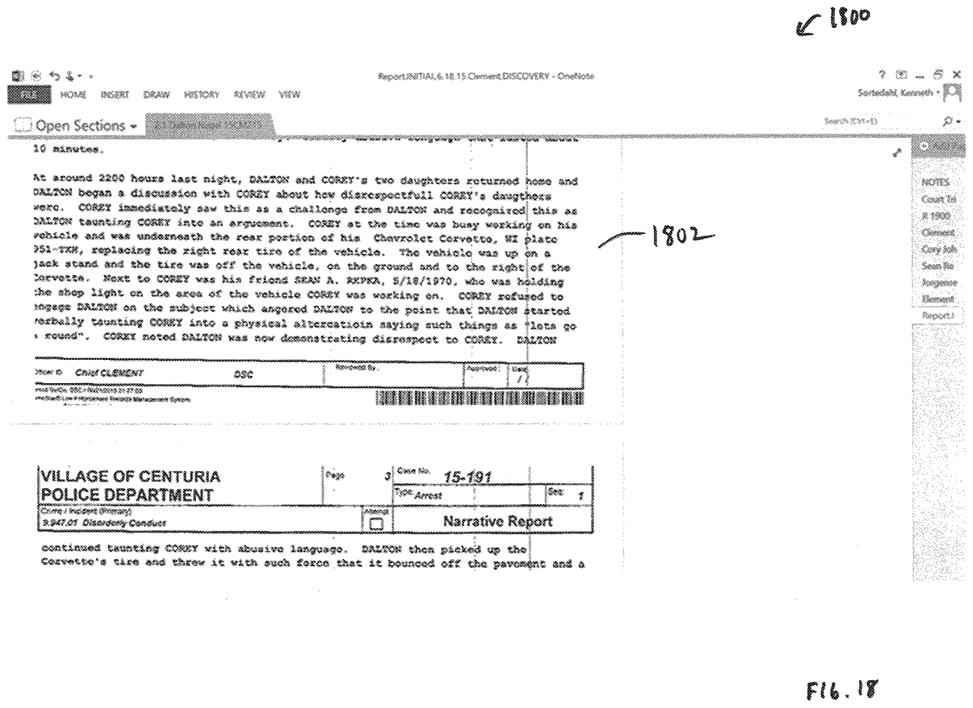

When the user has inserted tags into the various reports, then the user collects the tags by with the “Find Tags” command. The “Find Tags” command aggregates the tags, and each “smallest meaningful piece of information” into a page, a collection of the tags. An example is shown in the interface 1700 of FIG. 17. In this example, each tag 1702 (e.g., “E1 Identity”) includes those facts 1704 tagged by the tag 1702. The facts 1704 can be coded to correspond to particular witnesses or other aspects of the case.

Organizing the facts by element will be a help when closing. The user can search the page or section or multiple sections as follows (this is a soft search or a google search).

The word must be in a format the computer recognizes in order to search them. If the user copies a report into a page, the report will be inserted as a picture, and, since the computer does not recognized the words in a picture, the report cannot be word searched. One way to get the computer to recognize the words when searched is to retype them. That is self-explanatory and no further explanation is necessary. The second way to get OneNote to search for words is as follows. The user grabs with a click of the mouse while over the document icon and puts the document into the appropriate OneNote page. OneNote will ask the user to Attach the file or to insert a printout.

As previously described, if the user selects the “Attach file” command, then the icon will be inserted onto the page and when the user later double clicks the icon, it will open to the document. If the user selects the “Insert Printout” command then the report will display on the page.

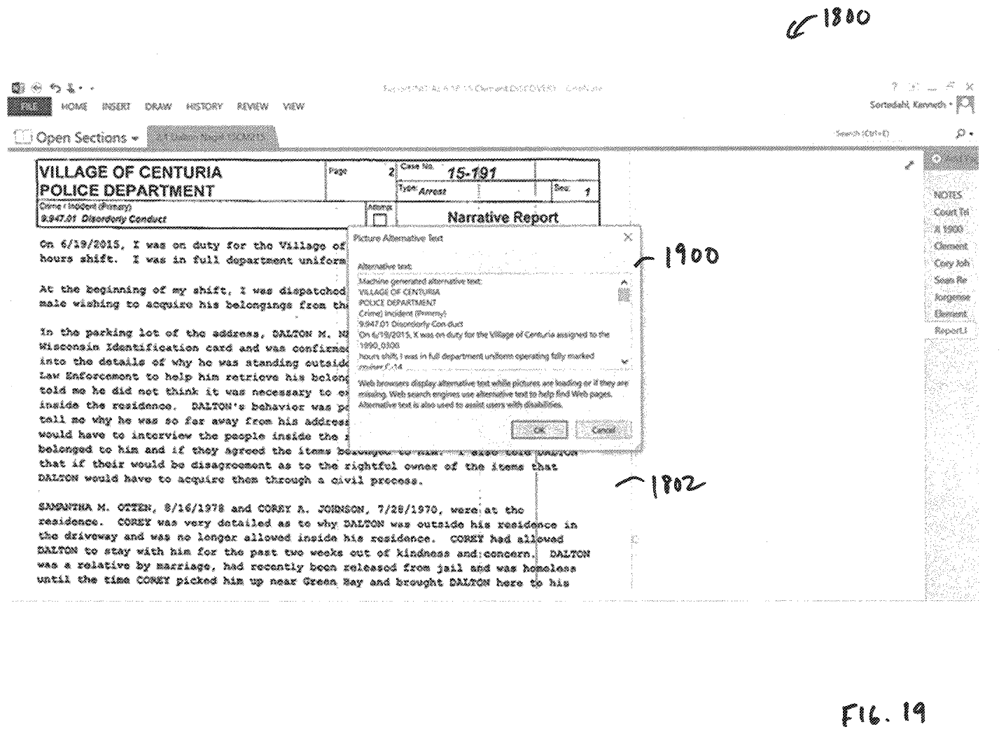

FIG. 18 is depicts an interface 1800 when the report is printed out and it is now contained on an OneNote page as a picture 1802.

Next, the user uses the character recognition command so that OneNote will recognize the words when they are searched by the user. This is done by right-clicking on the document and then selecting the “Make Image Searcheable” command.

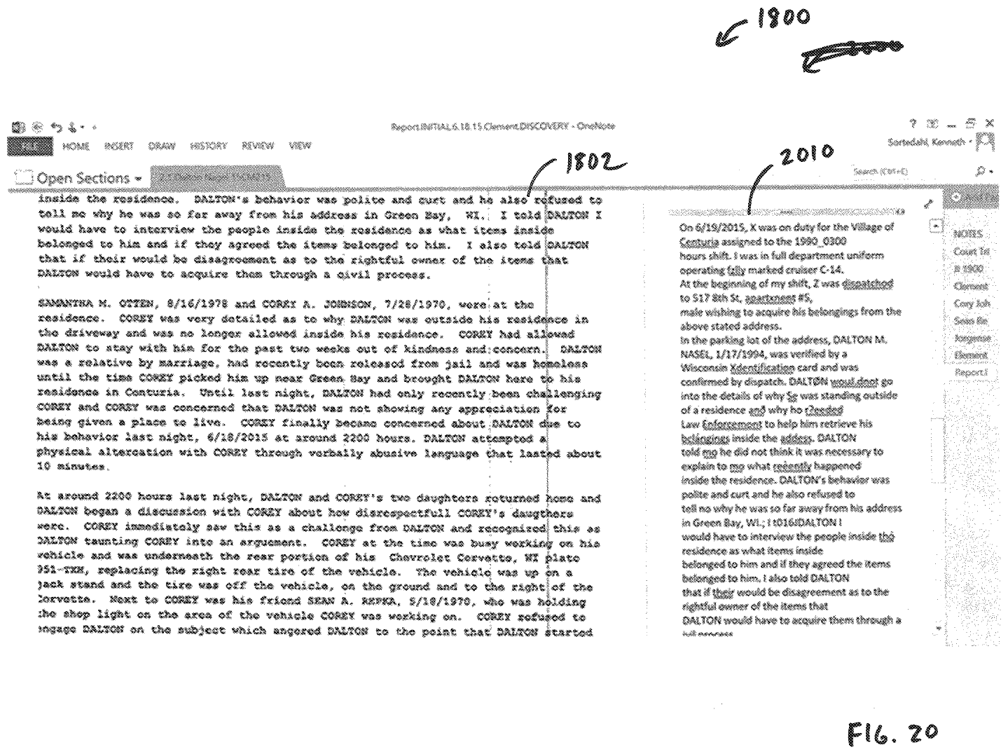

Now if the user selects the “Alt Text” command box 1900 as shown in FIG. 19 (above the Make Text in Image Searchable), the user can see and copy what the computer recognizes from the text picture)

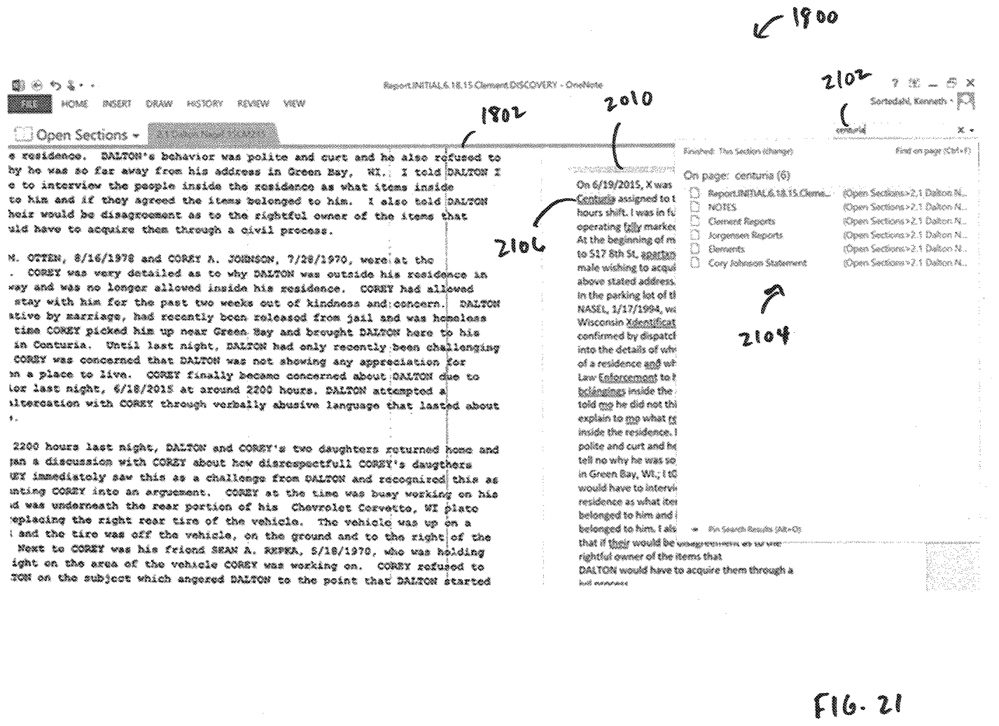

The problem is that some of the words can be misspelled or misrecognized and so when the user tries to search for them, they will not be found. So, the user can copy the words out of the text box, paste them in a new page or next to the picture, correct the words, and then the search function will work. An alternate approach is to correct the words in the text box, such as a text box 2010 shown on the interface 1800 in FIG. 20.

The pages or sections can be word searched by the user as follows.

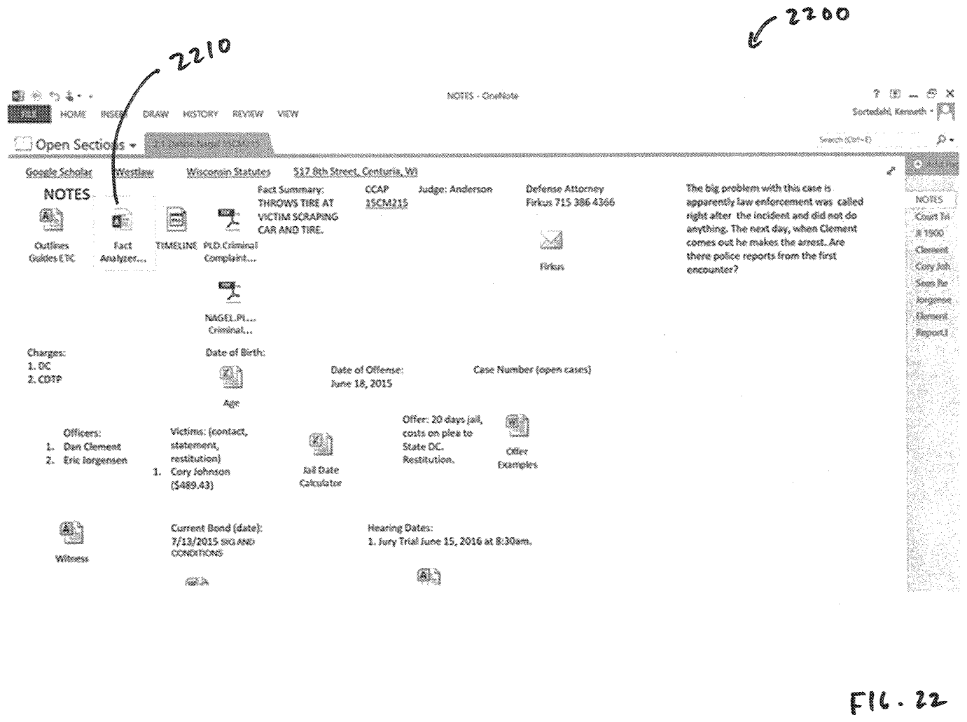

If the user selects “This Section” to search and then searches for “Centuria” in a search box 2102, OneNote will display a list 2104 of the pages with “Centuria” highlighted on them, as shown in FIG. 21. The user can scroll the list 2104 and select the page, click on the page and OneNote will take the user to a highlighted search word 2106.

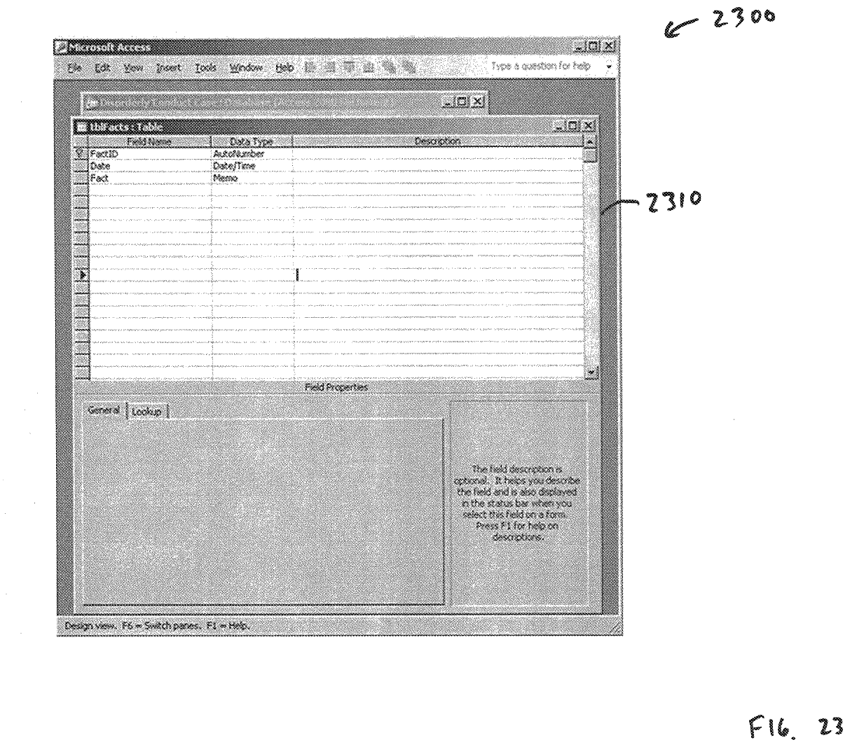

From the OneNote dashboard, the user can create a far more comprehensive organization of the case facts. An Access file 2210 is found on an example case dashboard 2200 shown in FIG. 22, called the “Fact Analyzer . . . ”

Access can be used to index a case. This can be used to index any grouping of information the user wants; not just a case but a class, a book, several books, a project, and/or researching a book. This is how it is done.

Microsoft Access is a relational database. This is an example of a simple case database.

The process is started by reducing the case to its smallest useful piece of information, the fact. The fact is the most basic building block of a case, such as: “John hit George”; “The hit happened at John's house at 8 PM on Apr. 24, 2013”; “George's eye swelled up”; “Officer came to John's house and photographed George's eye”; “George did not consent to John hitting him”; “John admitted to Officer that he hit George”; and “Neighbor said he heard commotion.”

Next, make a list of the people who appear in the case, such as: 1. John; 2. George; 3. Officer; and 4. Neighbor. Then, relate each fact to the relevant person and each person to the relevant fact. This allows the user to find all the facts in the case that relate to a person in the case. For instance:

John hit George. (1, 2)

The hit happened at John's house at 8 PM. (1)

George's eye swelled up. (2)

Officer came to John's house and photographed George's eye. (2, 3)

George did not consent to John hitting him. (2)

John admitted to Officer that he hit George. (1, 2, 3)

Neighbor said he heard commotion. (4)

Then make a list of the elements that require proof, such as: 1. Defendant (identity); 2. On (date); 3. At (venue); 4. While in a private or public place; 5. Did engage in violent, abusive, boisterous, profane, or otherwise disorderly conduct; 6. Under circumstances in which such conduct tended to cause a disturbance.

Relate each fact to the relevant element and each element to the relevant fact, such as:

John hit George. (1, 5)

The hit happened at John's house at 8 PM. (2, 3)

George's eye swelled up. (5, 6)

Officer came to John's house and photographed George's eye. (3, 4, 5)

George did not consent to John hitting him. (5, 6)

John admitted to Officer that he hit George. (1, 5, 6)

Neighbor said he heard commotion. (6)

Now imagine that the user can sort or index the facts by the elements and/or by the person. This is important because when one indexes by the person, the user will have a list of facts to which the person will be able to testify. The user will have a list of facts indexed by and related to each element that will become the basis for a closing argument. Lastly, the user will have the list of facts to use chronologically in the opening statement.

This is how to do it in Microsoft Access.

1. Open the Access Program,

2. Click on “Create a new file . . . ”

3. Click on “Blank database . . . ”

4. Go to the top of the window, at “Save in:” click the down arrow and select “Desktop” then go to “File name:” and name the file “Disorderly Conduct Case.” Click “Create.”

5. Double click on “Create table in Design view”.

6. In the box under “Field Name” type “FactID” in the box under “Data Type” click on the right side of the box and select “AutoNumber” from the pull down menu.

7. Under the second box under “Field Name” type “Date” in the second box under “Data Type” click on the right side of the box and select “Date/Time”.

8. Under the third box under “Field Name” type “Fact” under the third box under “Data Type” Click on the right side of the box and select “Memo”.

9. Now right click on the small box to the left side of “FactID” and select “Primary Key”. The resulting table 2310 in Design View of the interface 2300 is shown in FIG. 23.

10. Now close the table by clicking in the “x” on the upper right side of the window. Save.

11. When prompted, name the table “tblFacts”.

12. Now double click on “Create table in Design view”.

13. In the box under “Field Name” type “PersonID” in the box under “Data Type” click on the right side of the box and select “AutoNumber” from the pull down menu.

14. Under the second box under “Field Name” type “Name” in the second box under “Data Type” click on the right side of the box and select “Text”.

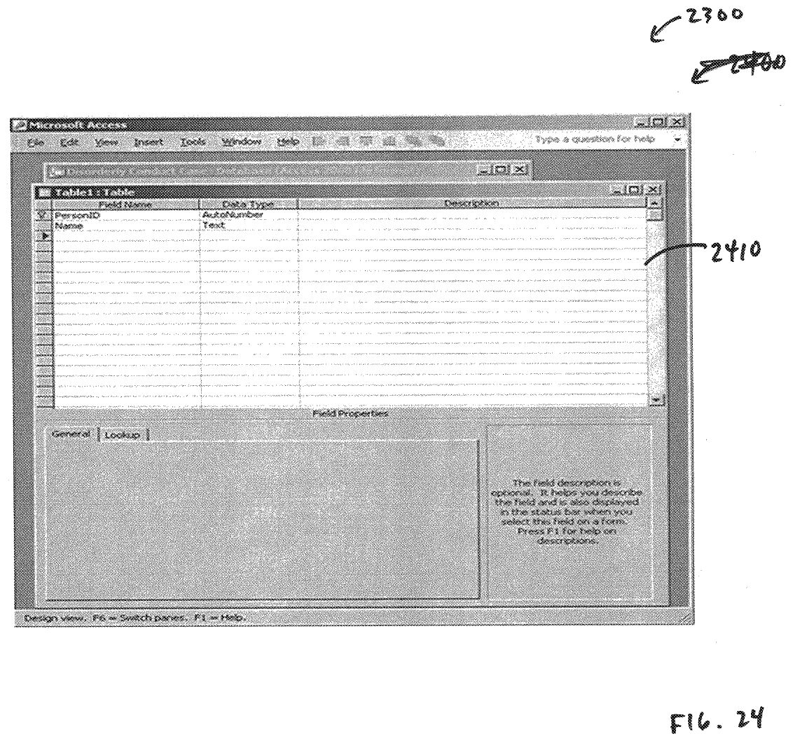

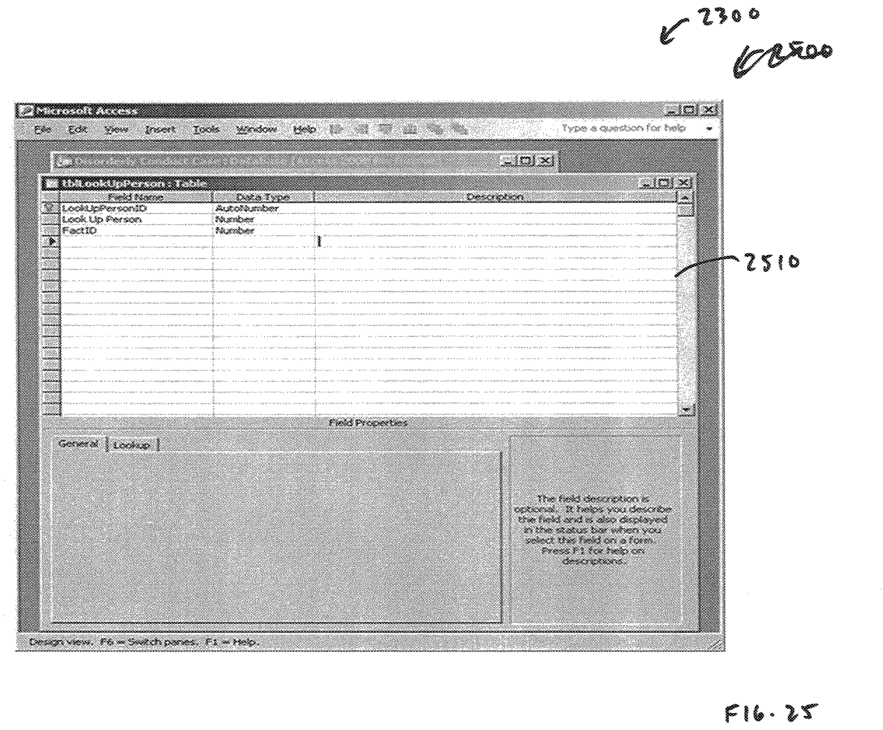

15. Now right click on the small box to the left side of “PersonID” and select “Primary Key”. The resulting table 2410 in Design View is shown in FIG. 24.

16. Now go to “File” click and “Save” on command box.

17. At “Table Name:” type “tblPerson” and click “OK.”

18. Click in the upper right box with the “x” to close the table.

19. Now go through the same procedure to make a table named “tblElements”

20. Now create a junction table.

21. Click on “Design”.

22. Under “Field Name” type “LookUpPersonID”.

23. Under “Data Type” click on the right side of the box and select “AutoNumber”.

24. In the second box under “Field Name” type “Look Up Person”.

25. In the second box under “Data Type” click on the right side of the box and select “Lookup Wizard . . .”

26. Keep the bullet on “I want the lookup column to look up the values in a table or query.” Click “Next>”.

27. At “Which table or query should provide the values for your lookup column?” Select “Table: tblPerson” Keep “View” bulleted at “Tables” then click “Next>”.

28. At “Which fields contain the values you want included in your lookup column? The fields you select become columns in your lookup column.” Click on the >button twice so both fields are transferred from the “Available Fields:” area to the “Selected Fields:” area. Then click “Next>”.

29. At “What sort order do you want for your list?” click on the down arrow and select “Name” Be sure the button to the right of “Name” says “Ascending”.

30. At “How wide would you like the columns in your lookup column?” Keep the “Hide key column (recommended) checked, grab the right side of the “Name” box with your mouse and pull it to the right.

31. At “What label would you like for your lookup column?” Leave it at “Look Up Person” and click the “Finish” button. When it says “The table must be saved. Do you want to save it?” Click “Yes” When it says “Save As Table Name:” type “tblLookUp Person”.

32. In the third box below “Field Name” type “FactID” in the third box under “Data Type” click on the right corner of the box and select “Number” from the drop down menu.

33. Right click on the small box to the left of “LookUpPersonID” and select “Primary Key”.

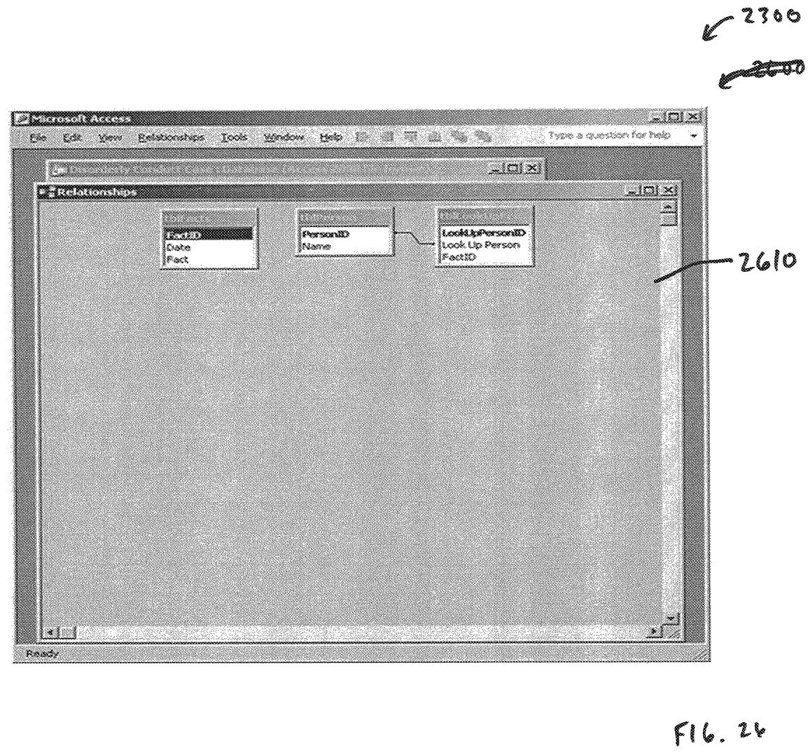

34. The design view of the resulting table 2510 is shown in FIG. 25.

35. Now click on the “x” in the upper right hand side of the window to close it.

36. Now go to the top of the window and click on “Tools” Click on “Relationships . . . ”

37. At “Show Table” Click on “tblFacts” click the “Add” button, then click on “tblLookUpPerson” click the “Add” button, then click on “tblPerson” and click the “Add” button. Then click on the “Close” button.

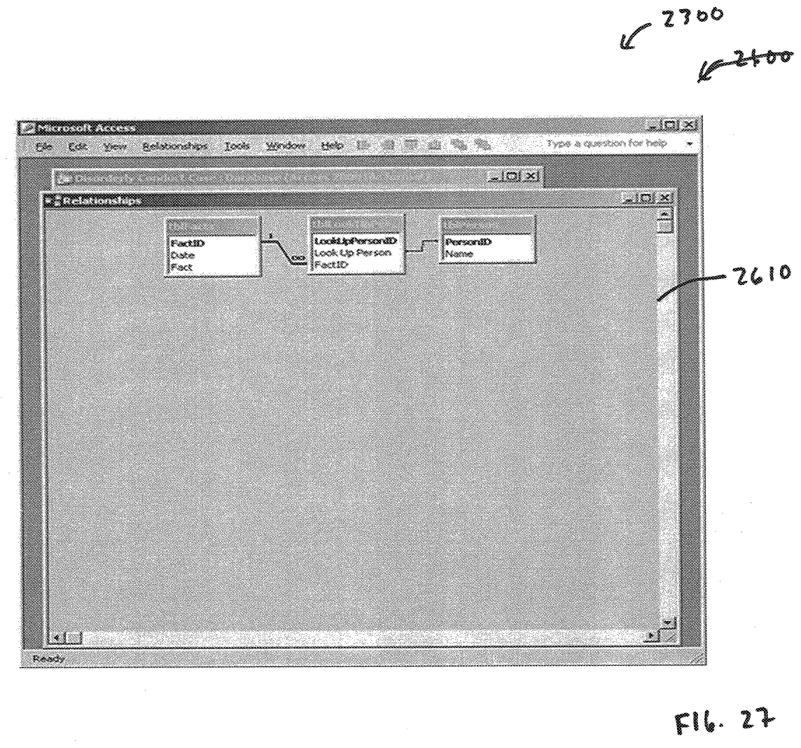

38. The “Relationships” window 2610 would look like that of FIG. 26.

39. Using a mouse, click on the top of the table named “tblPerson” and hold the mouse button down and move the table to the left of the table “tblLookUpPerson”.

40. Now click on the bold face “FactID”located in the “tblFacts” box and hold down the mouse and drag the mouse to the non-bold face “FactID” in the “tblLookUpPerson” Release the mouse button over the non-bold face “FactID” in the “Edit Relationships” box click the mouse in the “Enforce Referential Integrity” box, click the mouse in the “Cascade Update Related Fields” and click the mouse in the Cascade Delete Related Records.” Click on the “Create” box.

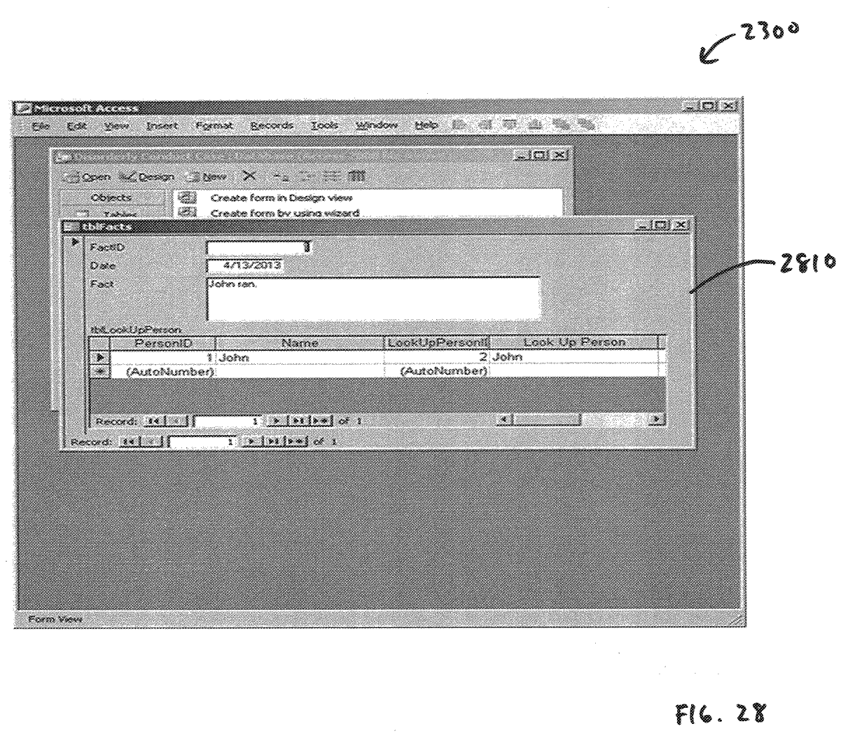

41. Now the “Relationships” window 2610 should look like that of FIG. 27.

42. Now close the “Relationships” box by clicking the mouse in the upper right hand

43. If it says, “Do you want to save changes to the layout of Relationships?”, Click “Yes”.

44. Click on “Forms” (under the “Objects” list).

45. Double click on the Icon that says “Create form by using wizard”.

46. Now create a form that shows how the facts relate to the person, later create a form that shows how the person relates to the facts.

47. Click on the >>button sending “FactID” “Date” and “Fact” to the “Selected Fields:” box.

48. Now go to “Tables/Queries” and click on the down arrow and select “tblTableLookUpPerson” and then press the >>button.

49. Go back to “Tables/Queries” and click on the down arrow and select “Table: tblPerson” and then press the >>button, now every field from every table should be in the “Selected Fields:” box. Click “Next”.

50. Where it says, “How do you want to view your data?”, maintain the selection of “by tblFacts” Click “Next”.

51. Where it says “What layout would you like for your subform?” maintain the bulleted selection of “Datasheet” and press “Next” then press “Next” at “What style would you like? Maintain the “Standard” selection and press “Next” at “What titles do you want for your forms?” Change these as “Form: frmFacts” and “Subform: frmLookUpPerson Subform” and click “Finish.”

52. Now create a second form that relates the person to the facts.

53. Click on the >>button sending “FactID” “Date” and “Fact” to the “Selected Fields:” box.

54. Now go to “Tables/Queries” and click on the down arrow and select “tblTableLookUpPerson” and then press the >>button.

55. Go back to “Tables/Queries” and click on the down arrow and select “Table: tblPerson” and then press the >>button, now every field from every table should be in the “Selected Fields:” box. Click “Next”.

56. Where it says, “How do you want to view your data?”, change the selection of “by tblFacts” to “by tblPerson” Click “Next”.

57. Where it says, “What layout would you like for your subform?”, maintain the bulleted selection of “Datasheet” and press “Next” then press “Next” at “What style would you like? Maintain the “Standard” selection and press “Next” at “What titles do you want for your forms?” Change these as “Form: frmPerson” and “Subform: frmLookUpPerson Subform1” and click “Finish.”

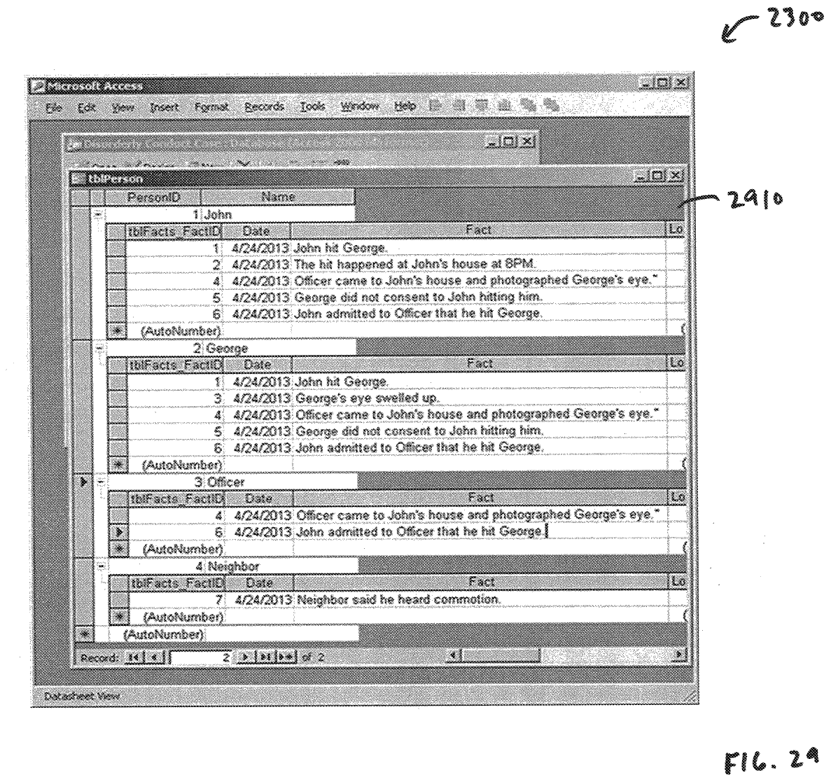

58. Now go to “frmFacts” and enter the data in the form 2810 that should look like that of FIG. 28.

59. After you enter the data, go to the command bar “View” and select “Datasheet View” from the drop down list. Then click on the “+” to see the people related to the fact.

60. It should look like the data sheet 2910 shown in FIG. 29.

61. Close that window and double click on “frmPerson” then go to the command bar “View” and select “Datasheet View” from the drop down list. Then click on the “+” to see the facts related to the person.

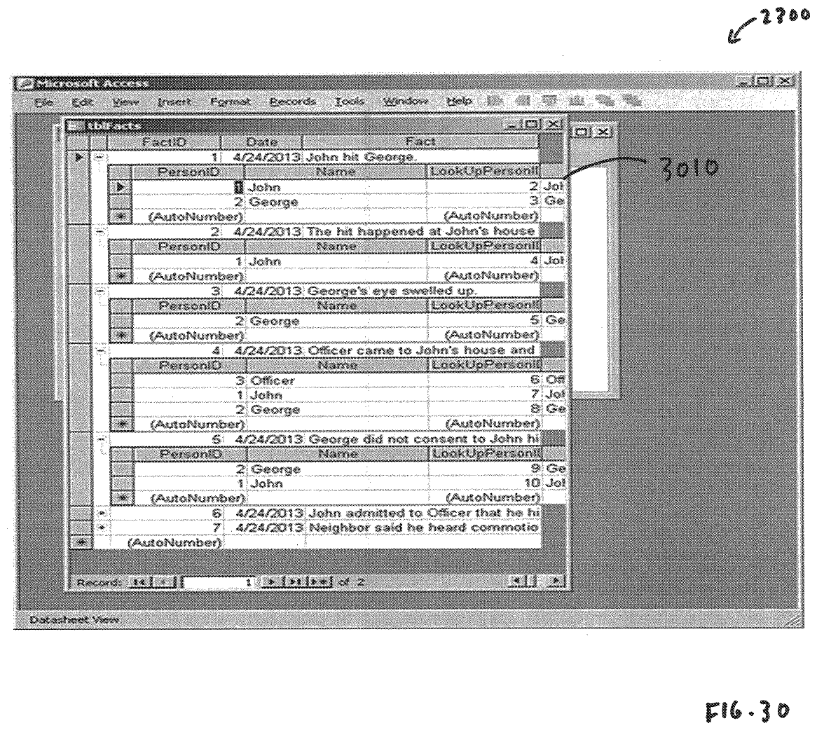

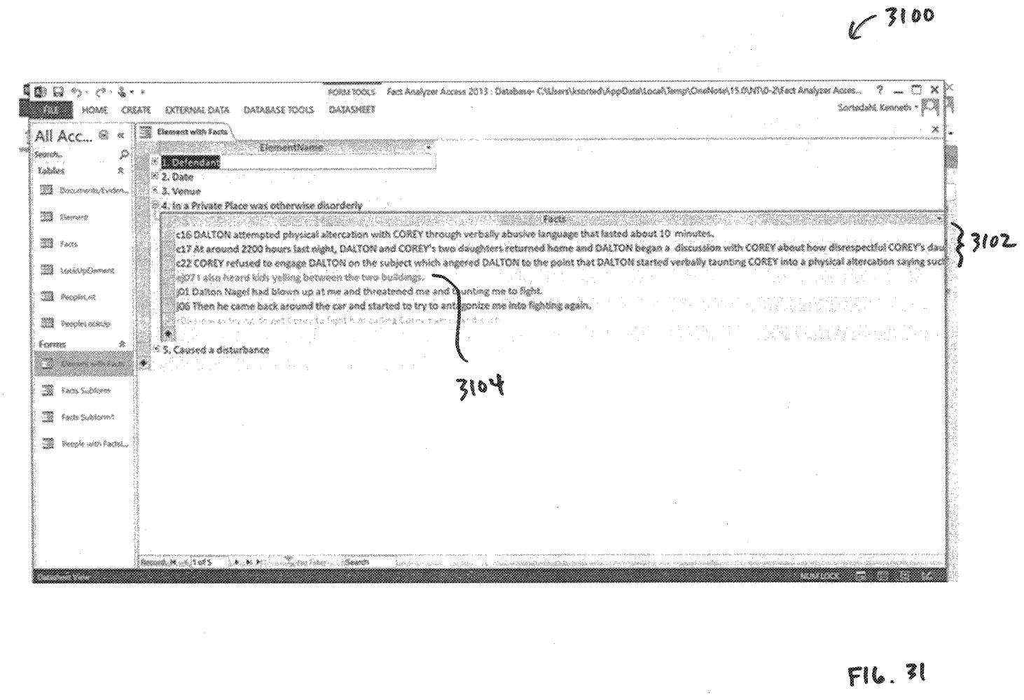

62. It should look like the form 3010 shown in FIG. 30.

63. Now add the tables for the elements to the facts in the same way that the tables for the persons were added.

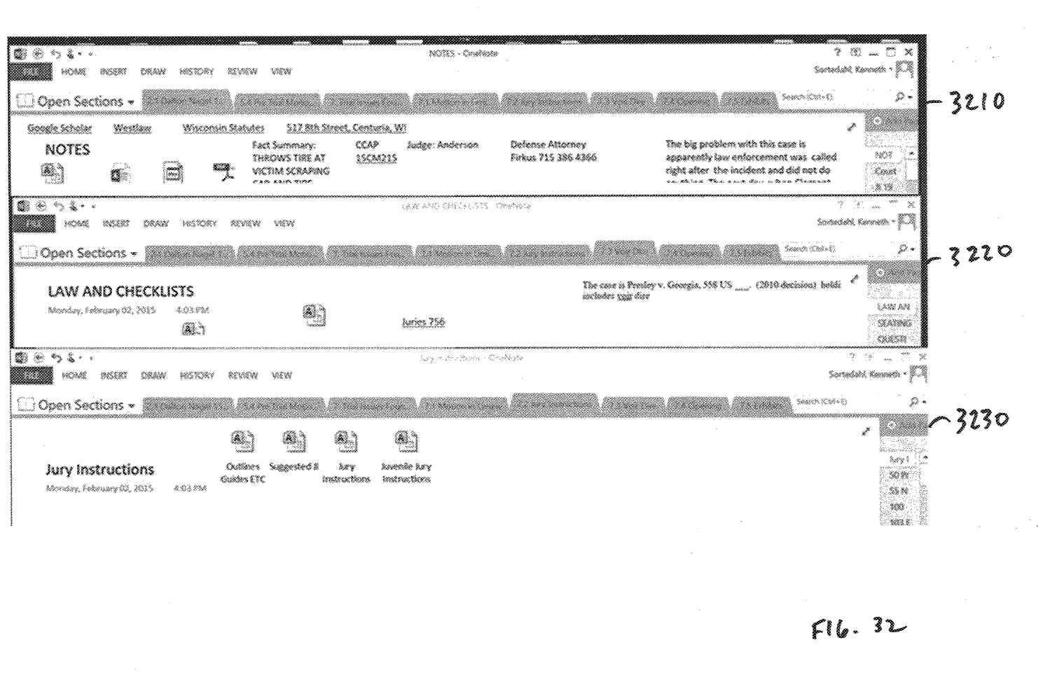

64. To add color fonts, highlights, underline, strikethrough and bold to the facts, designate the facts as “Long Text” as the data type in the set up portion of the fact table. Then go down the screen to the “General” list and find the line that says “Plain Text” click on the line and the drop down menu will say “Plain Text” or “Rich Text” select the “Rich Text” command. Now the Fact or Smallest Meaningful piece of information can have its own uniform color. So for example, the user can use a single color such as red for all arresting officer “Facts” 3102, including c16, c17, c22. Now anytime the user sees red, he or she will know it is the arresting officer, as shown in the interface 3100 of FIG. 31. Another color, such as green, can be used to distinguish other facts 3104.

This is how to import data from a document into an Access table.

Put the text into Notepad, then after every sentence hit “enter.”

Go to “Get External Data” under “File”, then “Import.”

Select text file one wants to import. (Be sure file type has “text” (.txt) files selected).

Select the “delimited” option.

Use “.” (a period) to separate fields.

Store the data in a new table.

Click the advanced tab.

Change the “Decimal Symbol” to anything but “.” (a period).

Now this entire list is copied and pasted into “Facts” Subdatasheet under (+).

Another way is to separate every sentence as described above in a Notepad document, then copy into a table where one has highlighted a new column.

As shown in FIG. 32, by typing the Command “Control M” when OneNote is open, the user creates identical copies 3210, 3220, 3230 of OneNote that are open at the same time and can be opened to different places (e.g., Notes vs. Law and checklists vs. Jury instructions) and the different places can be looked at by the user at the same time. Also changes that are made to one copy automatically update all copies so that if co-counsel makes a change to the copy they are working with all copies are updated. This will be useful when the user dons AI goggles such as the Hololens, The Meta, or the goggles.

The larger the display, the better it would seem, the Control M function would work.

The system described herein can be implemented on one or more computing devices. Each of these computing devices can include a processor and non-transitory memory.

More specifically, each computing device can include various components, including a memory, a processing system, a secondary storage device, a network interface card, a video interface, a display unit, and an external component interface. In other embodiments, computing devices are implemented using more or fewer hardware components. For instance, in another example embodiment, a computing device does not include a video interface, a display unit, an external storage device, or an input device.

The term computer readable media as used herein may include computer storage media. Computer storage media may include volatile and nonvolatile, removable and non-removable media implemented in any method or technology for storage of information, such as computer readable instructions, data structures, program modules, or other data. The memory includes one or more computer storage media capable of storing data and/or instructions. As used in this document, a computer storage medium is a device or article of manufacture that stores data and/or software instructions readable by a computing device. In different embodiments, the memory is implemented in different ways. For instance, in various embodiments, the memory is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The processing system includes one or more physical integrated circuits that selectively execute software instructions. In various embodiments, the processing system is implemented in various ways. For example, the processing system can be implemented as one or more processing cores. In this example, the processing system can comprise one or more Intel microprocessors. In another example, the processing system can comprise one or more separate microprocessors.

The secondary storage device includes one or more computer storage media. The secondary storage device stores data and software instructions not directly accessible by the processing system. In other words, the processing system performs an I/O operation to retrieve data and/or software instructions from the secondary storage device. In various embodiments, the secondary storage device is implemented by various types of computer-readable data storage media. For instance, the secondary storage device may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card enables the computing device to send data to and receive data from a communication network. In different embodiments, the network interface card is implemented in different ways. For example, in various embodiments, the network interface card is implemented as an Ethernet interface, a token-ring network interface, a fiber optic network interface, a wireless network interface (e.g., WiFi, WiMax, etc.), or another type of network interface.

The video interface enables the computing device to output video information to the display unit. In different embodiments, the video interface is implemented in different ways. For instance, in one example embodiment, the video interface is integrated into a motherboard of the computing device. In another example embodiment, the video interface is a video expansion card. In various embodiments, the display unit can be a cathode-ray tube display, an LCD display panel, a plasma screen display panel, a touch-sensitive display panel, an LED screen, a projector, or another type of display unit. In various embodiments, the video interface communicates with the display unit in various ways. For example, the video interface can communicate with the display unit via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface enables the computing device to communicate with external devices. In various embodiments, the external component interface is implemented in different ways. For example, the external component interface can be a USB interface, a FireWire interface, a serial port interface, a parallel port interface, a PS/2 interface, and/or another type of interface that enables the computing device to communicate with external devices. In different embodiments, the external component interface enables the computing device to communicate with different external components. For example, the external component interface can enable the computing device to communicate with external storage devices, input devices, speakers, phone charging jacks, modems, media player docks, other computing devices, scanners, digital cameras, a fingerprint reader, and other devices that can be connected to the computing device. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, key pads, microphones, joysticks, touch-sensitive display screens, and other types of devices that provide user input to the computing device.

The memory stores various types of data and/or software instructions. For instance, in one example, the memory stores a Basic Input/Output System (BIOS), and an operating system. The BIOS includes a set of software instructions that, when executed by the processing system, cause the computing device to boot up. The operating system includes a set of software instructions that, when executed by the processing system, cause the computing device to provide an operating system that coordinates the activities and sharing of resources of the computing device.

The memory also stores one or more software applications that can be executed. For instance, Microsoft OneNote and Microsoft Access can be used to implement much of the functionality described herein. It is also possible that other software applications can also be used.

In the example described herein, the functionality is logically grouped into modules that perform the relevant functionality of the system. This can generally include one or more of: a case module programmed to manage a plurality of litigations, with each litigation including a dashboard including links to a plurality of items associated with the litigation; a template module programmed to provide a plurality of templates associated with parts of the litigation, the parts including both portions of a trial and rules associated therewith; a witness module programmed to store information about a plurality of individuals associated with the litigation; and a facts module programmed to store a plurality of facts associated with the litigation.

The examples provided herein allow the computing devices to more efficiently and easily manage and display litigation information. For example, the system provided herein provides for enhanced processing of the litigation materials, including documents, facts, etc. This allows the computing devices to process the data more efficiently. The system also allows for the enhanced display of the litigation data. This allows the computing devices to be more efficiently when displaying the data in one or more graphical user interfaces.

While the examples provided herein are related to litigation, the concepts can be applied to any system including multiple sources of information involving facts. The system can be used to access and reassemble this information into a multi-index (fact/individual/theme) as described above. As noted above, the concepts could be applied in other instances to a class, a book, several books, a project, and/or researching a book. The system of organization can utilize the tags (e.g., in OneNote) to bunch into a library (stem leaf) to index such information in a database (e.g., Access).

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for managing litigation, the system comprising:
a processor; and
memory encoding instructions that, when executed by the processor, cause the system to create:
a case module programmed to manage a plurality of litigations, with each litigation including a dashboard including links to a plurality of items associated with the litigation;
a template module programmed to provide a plurality of templates associated with parts of the litigation, the parts including both portions of a trial and rules associated therewith;
a witness module programmed to store information about a plurality of individuals associated with the litigation; and
a facts module programmed to store a plurality of facts associated with the litigation;
wherein the facts are coded to link the facts to the individuals.

2. The system of claim 1, wherein the memory encodes further instructions that, when executed by the processor, cause the system to define the dashboard as a Microsoft OneNote file include links to a plurality of documents associated with the litigation.

3. The system of claim 1, wherein the memory encodes further instructions that, when executed by the processor, cause the system to define the templates as Microsoft OneNote files.

4. The system of claim 3, wherein the memory encodes further instructions that, when executed by the processor, cause the system to code the Microsoft OneNote files so that the Microsoft OneNote files are sorted.

5. The system of claim 1, wherein the memory encodes further instructions that, when executed by the processor, cause the system to create a documents module programmed to house a plurality of documents associated with the litigation, wherein the plurality of documents are searchable.

6. The system of claim 5, wherein portions of the documents are coded to link the portions to the individuals, the facts, or themes associated with the litigation.

7. The system of claim 6, wherein the portions are coded by color.

8. The system of claim 1, wherein the memory encodes further instructions that, when executed by the processor, cause the system to provide tags associated with the trial and rules associated therewith, wherein the tags are associable with the individuals and the facts.

9. The system of claim 8, wherein each of the tags includes a tag name and a tag code, the tag code including a unique color or style.

10. The system of claim 8, wherein the memory encodes further instructions that, when executed by the processor, cause the system to be searchable to list each of the tags and the individuals, facts, and themes associated therewith.

11. The system of claim 1, wherein the case module stores the items in a relational database to allow the items to be applied to multiple sets of facts.

12. The system of claim 1, wherein multiple instances of the case module are instantiable at a same time.
